(19) United States
(12) Patent Application Publication
(10) Pub. No.: US 2017/0308792 A1
(43) Pub. Date: Oct. 26, 2017

(54) Knowledge To User Mapping in Knowledge Automation System

(71) Applicant: Prysm, Inc., San Jose, CA (US)

(72) Inventors: Tao Liang, Palo Alto, CA (US); Sanjay Mehta, Fremont, CA (US); Ravindra Guntur, Pune (IN); Krusheel Munnangi, Bangalore (IN); Sindhu Priyadarshini, Mysore (IN)

(21) Appl. No.: 15/136,072

(22) Filed: Apr. 22, 2016

(51) Int. Cl. G06N 5/02; G06N 99/00

(52) U.S. Cl. CPC G06N 5/02; G06N 99/005

(57) ABSTRACT

Knowledge automation techniques may include generating, for each user of a plurality of users, a user vector associated with the user, and grouping the generated user vectors into clusters based on a clustering distance metric between the user vectors. For each cluster, the techniques may include determining a centroid of the cluster, and associating with the cluster at least some of the knowledge elements that the users associated with the cluster has interacted with. The techniques may further include comparing a target user vector of a target user with the centroids of the clusters to determine a matching cluster for the target user, and providing one or more recommendations of the knowledge elements that are associated with the matching cluster to the target user.

### CROSS-REFERENCES TO RELATED APPLICATIONS

The present application is a continuation-in-part of International Application No. PCT/US2015/044047 filed Aug. 6, 2015, entitled “Knowledge Automation System,” which claims the benefit and priority of U.S. Provisional Application No. 62/033,943 filed Aug. 6, 2014, U.S. Provisional Application No. 62/034,759 filed Aug. 7, 2014, U.S. Provisional Application No. 62/054,340 filed Sep. 23, 2014, U.S. Provisional Application No. 62/065,591 filed Oct. 17, 2014, and U.S. Provisional Application No. 62/065,603 filed Oct. 17, 2014, the entire contents of all of which are incorporated herein by reference for all purposes.

### BACKGROUND

The present disclosure generally relates to knowledge automation. More particularly, techniques are disclosed for mapping knowledge to users within a knowledge automation system.

With the vast amount of data content available, users often suffer from information overload. For example, in an enterprise environment, a large corporation may store all the data that users need to complete their tasks. However, finding the right data for the right user can be challenging. Users may often spend substantial amount of time looking for a needle in a haystack in trying to find the right data to fill their particular needs from thousands of data files. In a collaborative environment, even after the right data is found, substantial amount of time may be needed to synthesis that data into a suitable output that can be consumed by others. The amount of time that users spend searching and synthesizing the data may also create excessive load on the enterprise computing systems and slow down the processing of other tasks.

Embodiments of the present invention address these and other problems individually and collectively.

### BRIEF SUMMARY

The present disclosure generally relates to knowledge automation. More particularly, knowledge automation techniques are disclosed for mapping knowledge to users within a knowledge automation system.

In some embodiments, the techniques can be performed by a data processing system implementing a knowledge automation system, and may include generating, for each user of a plurality of users, a user vector associated with the user. The user vector may include one or more of seeded profile information of the user, interaction data of user interactions with knowledge elements of the data processing system, and/or knowledge element metadata of the knowledge elements that the user interacted with. The techniques may also include grouping the generated user vectors into clusters based on a clustering distance metric between the user vectors. For each cluster, the techniques may include determining a centroid of the cluster, and associating with the cluster at least some of the knowledge elements that the users associated with the cluster has interacted with.

The techniques may further include comparing a target user vector of a target user with the centroids of the clusters to determine a matching cluster for the target user, and providing one or more recommendations of the knowledge elements that are associated with the matching cluster to the target user. In some embodiments, the seeded profile information, the interaction data, and the knowledge element metadata are maskable when grouping the generated user vectors into the clusters. In some embodiments, techniques for providing the one or more recommendations may include filtering out knowledge elements that the target user has consumed, knowledge elements that are stale, and/or knowledge elements that have low ratings.

In some embodiments, the seeded profile information of the user may include one or more of a job junction of the user, a role of the user, an expertise of the user, an age of the user, a location of the user, and a gender of the user. In some embodiments, the user interactions between the user and a knowledge element may include one or more of viewing the knowledge element, commenting on the knowledge element, rating of the knowledge element, sharing of the knowledge element, and publishing of the knowledge element performed by the user. In some embodiments, the knowledge element metadata of a knowledge element may include one or more of key terms associated with the knowledge element, a publisher of the knowledge element, a title of the knowledge element, a topic of the knowledge element, a category associated with the knowledge element, and a timestamp of the knowledge element.

In some embodiments, a non-transitory computer-readable storage memory may store a plurality of instructions executable by one or more processors. The plurality of instructions may include instructions to perform the techniques described above. In some embodiments, a system may include one or more processors, and a memory coupled with and readable by the one or more processors. The memory can be configured to store a set of instructions which, when executed by the one or more processors, causes the one or more processors to perform the techniques described above.

### BRIEF DESCRIPTION OF THE DRAWINGS

FIG. 1 illustrates an environment in which a knowledge automation system can be implemented, according to some embodiments.

FIG. 2 illustrates a flow diagram depicting some of the processing that can be performed by a knowledge automation system, according to some embodiments.

FIG. 3 illustrates a block diagram of a knowledge automation system, according to some embodiments.

FIG. 4 illustrates a user profile, according to some embodiments.

FIG. 5 illustrates a user profile group, according to some embodiments.

FIG. 6 illustrates an example formation of a knowledge pack, according to some embodiments.

FIG. 7 illustrates a knowledge bank, according to some embodiments.

FIG. 8 illustrates a block diagram of a content synthesizer, according to some embodiments.

FIG. 9 illustrates a block diagram of a content analyzer, according to some embodiments.

FIG. 10 illustrates a flow diagram of a content discovery and ingestion process, according to some embodiments.

FIG. 11 illustrates a flow diagram of a content analysis process, according to some embodiments.

FIG. 12 illustrates an example of a graphical representation of a knowledge corpus of a knowledge automation system, according to some embodiments.

FIG. 13 illustrates an example of a graphical representation of a knowledge map, according to some embodiments.

FIG. 14 illustrates a flow diagram of a knowledge mapping process, according to some embodiments.

FIG. 15 illustrates a diagram of a user's interest level in identified content and a graphical user interface for adjusting the interest levels, according to some embodiments.

FIG. 16 illustrates a conceptual diagram of grouping user vectors into clusters, according to some embodiments.

FIG. 17 illustrates a flow diagram of a knowledge mapping process, according to some embodiments.

FIG. 18 illustrates a conceptual diagram of adaptive feedback provided by a knowledge automation system during the creation of a knowledge pack, according to some embodiments.

FIG. 19 illustrates another conceptual diagram of adaptive feedback provided by a knowledge automation system during the creation of a knowledge pack, according to some embodiments.

FIG. 20 illustrates a flow diagram of an adaptive feedback process, according to some embodiments.

FIG. 21 illustrates a flow diagram of another adaptive feedback process, according to some embodiments.

FIG. 22 illustrates a graphical user interface for building a knowledge pack, according to some embodiments.

FIG. 23 illustrates a flow diagram of a process for displaying a knowledge pack builder graphical user interface, according to some embodiments.

FIG. 24 illustrates a conceptual diagram of potential knowledge gaps in a knowledge automation system, according to some embodiments.

FIG. 25 illustrates a flow diagram of a process for automatically identifying a knowledge gap that can be performed by a knowledge automation system, according to some embodiments.

FIG. 26 depicts a block diagram of a computing system, according to some embodiments

FIG. 27 depicts a block diagram of a service provider system, according to some embodiments.

### DETAILED DESCRIPTION

The present disclosure relates generally to knowledge automation. Certain techniques are disclosed for mapping knowledge to users within a knowledge automation system.

Substantial amounts of data (e.g., data files such as documents, emails, images, code, and other content, etc.) may be available to users in an enterprise. These users may rely on information contained in the data to assist them in performing their tasks. The users may also rely on information contained in the data to generate useful knowledge that is consumed by other users. For example, a team of users may take technical specifications related to a new product release, and generate a set of training materials for the technicians who will install the new product. However, the large quantities of data available to these users may make it difficult to identify the right information to use.

Machine learning techniques can analyze content at scale (e.g., enterprise-wide and beyond) and identify patterns of what is most useful to which users. Machine learning can be used to model both the content accessible by an enterprise system (e.g., local storage, remote storage, and cloud storage services, such as SharePoint, Google Drive, Box, etc.), and the users who request, view, and otherwise interact with the content. Based on a user's profile and how the user interacts with the available content, each user's interests, expertise, and peers can be modeled. The data content can then be matched to the appropriate users who would most likely be interested in that content. In this manner, the right knowledge can be provided to the right users at the right time. This not only improves the efficiency of the users in identifying and consuming knowledge relevant for each user, but also improves the efficiency of computing systems by freeing up computing resources that would otherwise be consumed by efforts to search and locate the right knowledge, and allowing these computing resources to be allocated for other tasks.

### Architecture Overview

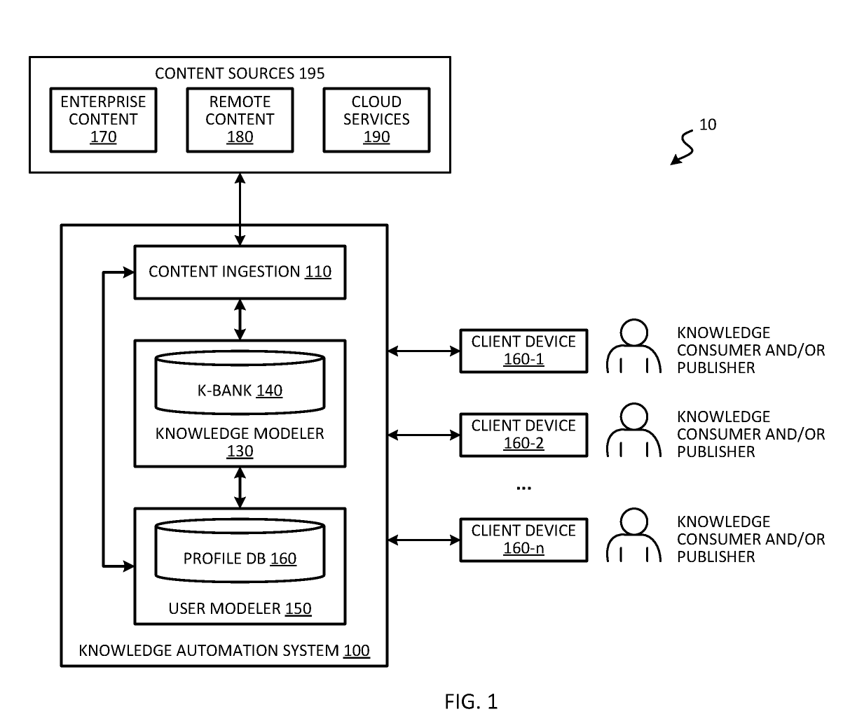

FIG. 1 illustrates an environment 10 in which a knowledge automation system 100 can be implemented, according to some embodiments. As shown in FIG. 1, a number of client devices 160-1, 160-2, . . . 160-n can be used by a number of users to access services provided by knowledge automation system 100. The client devices may be of various different types, including, but not limited to personal computers, desktops, mobile or handheld devices such as laptops, smart phones, tablets, etc., and other types of devices. Each of the users can be a knowledge consumer who accesses knowledge from knowledge automation system 100, or a knowledge publisher who publishes or generates knowledge in knowledge automation system 100 for consumption by other users. In some embodiments, a user can be both a knowledge consumer or a knowledge publisher, and a knowledge consumer or a knowledge publisher may refer to a single user or a user group that includes multiple users.

Knowledge automation system 100 can be implemented as a data processing system, and may discover and analyze content from one or more content sources 195 stored in one or more data repositories, such as a databases, file systems, management systems, email servers, object stores, and/or other repositories or data stores. In some embodiments, client devices 160-1, 160-2, . . . 160-n can access the services provided by knowledge automation system 100 through a network such as the Internet, a wide area network (WAN), a local area network (LAN), an Ethernet network, a public or private network, a wired network, a wireless network, or a combination thereof. Content sources 195 may include enterprise content 170 maintained by an enterprise, remote content 180 maintained at one or more remote locations (e.g., the Internet), cloud services content 190 maintained by cloud storage service providers, etc. Content sources 195 can be accessible to knowledge automation system 100 through a local interface, or through a network interface connecting knowledge automation system 100 to the content sources via one or more of the networks described above. In some embodiments, one or more of the content sources 195, one or more of the client devices 160-1, 160-2, . . . 160-n, and knowledge automation system 100 can be part of the same network, or can be part of different networks.

Each client device can request and receive knowledge automation services from knowledge automation system 100. Knowledge automation system 100 may include various software applications that provide knowledge-based services to the client devices. In some embodiments, the client devices can access knowledge automation system 100 through a thin client or web browser executing on each client device. Such software as a service (SaaS) models allow multiple different clients (e.g., clients corresponding to different customer entities) to receive services provided by the software applications without installing, hosting, and maintaining the software themselves on the client device.

Knowledge automation system 100 may include a content ingestion module 110, a knowledge modeler 130, and a user modeler 150, which collectively may extract information from data content accessible from content sources 195, derive knowledge from the extracted information, and provide recommendation of particular knowledge to particular clients. Knowledge automation system 100 can provide a number of knowledge services based on the ingested content. For example, a corporate dictionary can automatically be generated, maintained, and shared among users in the enterprise. A user's interest patterns (e.g., the content the user typically views) can be identified and used to provide personalized search results to the user. In some embodiments, user requests can be monitored to detect missing content, and knowledge automation system 100 may perform knowledge brokering to fill these knowledge gaps. In some embodiments, users can define knowledge campaigns to generate and distribute content to users in an enterprise, monitor the usefulness of the content to the users, and make changes to the content to improve its usefulness.

Content ingestion module 110 can identify and analyze enterprise content 170 (e.g., files and documents, other data such as e-mails, web pages, enterprise records, code, etc. maintained by the enterprise), remote content 180 (e.g., files, documents, and other data, etc. stored in remote databases), cloud services content 190 (e.g., files, documents, and other data, etc. accessible form the cloud), and/or content from other sources. For example, content ingestion module 110 may crawl or mine one or more of the content sources to identify the content stored therein, and/or monitor the content sources to identify content as they are being modified or added to the content sources. Content ingestion module 110 may parse and synthesize the content to identify the information contained in the content and the relationships of such information. In some embodiments, ingestion can include normalizing the content into a common format, and storing the content as one or more knowledge units in a knowledge bank 140 (e.g., a knowledge data store). In some embodiments, content can be divided into one or more portions during ingestion. For example, a new product manual may describe a number of new features associated with a new product launch. During ingestion, those portions of the product manual directed to the new features may be extracted from the manual and stored as separate knowledge units. These knowledge units can be tagged or otherwise be associated with metadata that can be used to indicate that these knowledge units are related to the new product features. In some embodiments, content ingestion module 110 may also perform access control mapping to restrict certain users from being able to access certain knowledge units.

Knowledge modeler 130 may analyze the knowledge units generated by content ingestion module 120, and combine or group knowledge units together to form knowledge packs. A knowledge pack may include various related knowledge units (e.g., several knowledge units related to a new product launch can be combined into a new product knowledge pack). In some embodiments, a knowledge pack can be formed by combining other knowledge packs, or a mixture of knowledge unit(s) and knowledge pack(s). The knowledge packs can be stored in knowledge bank 140 together with the knowledge units, or be stored separately. Knowledge modeler 130 may automatically generate knowledge packs by analyzing the topics covered by each knowledge unit, and combining knowledge units covering a similar topic into a knowledge pack. In some embodiments, knowledge modeler 130 may allow a user (e.g., a knowledge publisher) to build custom knowledge packs, and to publish custom knowledge packs for consumption by other users.

User modeler 150 may monitor user activities on the system as they interact with the knowledge bank 140 and the knowledge units and knowledge packs stored therein (e.g., the user's search history, knowledge units and knowledge packs consumed, knowledge packs published, time spent viewing each knowledge pack and/or search results, etc.). User modeler 150 may maintain a profile database 160 that stores user profiles for users of knowledge automation system 100. User modeler 150 may augment the user profiles with behavioral information based on user activities. By analyzing the user profile information, user modeler 150 can match a particular user to knowledge packs that the user may be interested in, and provide the recommendations to that user. For example, if a user has a recent history of viewing knowledge packs directed to a wireless networks, user modeler module 150 may recommend other knowledge packs directed to wireless networks to the user. As the user interacts with the system, user modeler 150 can dynamically modify the recommendations based on the user's behavior. User modeler 150 may also analyze search results performed by users to determine the effectiveness of the search results successful (e.g., did the user select and use the results), and to identify potential knowledge gaps in the system. In some embodiments, user modeler 150 may provide these knowledge gaps to content ingestion module 310 to find useful content to fill the knowledge gaps.

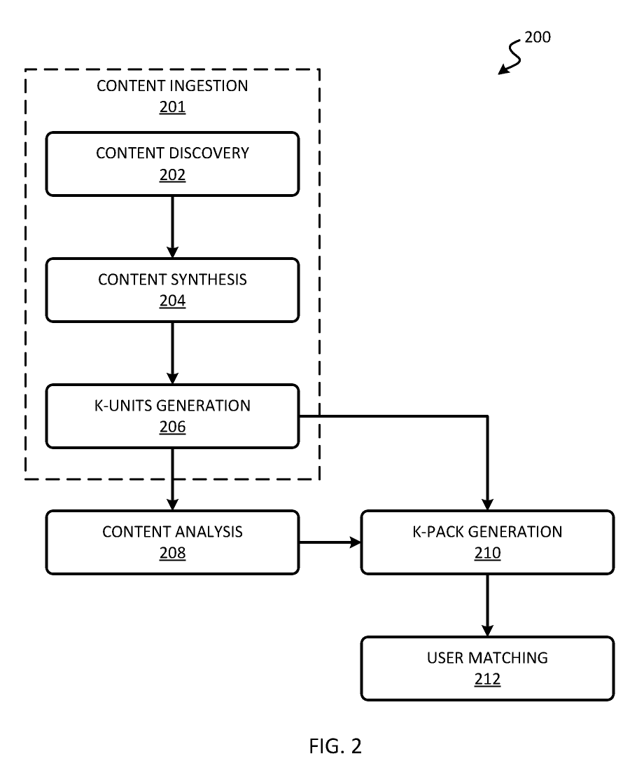

FIG. 2 illustrates a simplified flow diagram 200 depicting some of the processing that can be performed, for example, by a knowledge automation system, according to some embodiments. The processing depicted in FIG. 2 may be implemented in software (e.g., code, instructions, program) executed by one or more processing units (e.g., processors, cores), hardware, or combinations thereof. The software may be stored in memory (e.g., on a non-transitory computer-readable storage medium such as a memory device).

The processing illustrated in flow diagram 200 may begin with content ingestion 201. Content ingestion 201 may include content discovery 202, content synthesis 204, and knowledge units generation 206. Content ingestion 201 can be initiated at block 202 by performing content discovery to identify and discover data content (e.g., data files) at one or more data sources such as one or more data repositories. At block 204, content synthesis is performed on the discovered data content to identify information contained in the content. The content synthesis may analyze text, patterns, and metadata variables of the data content.

At block 206, knowledge units are generated from the data content based on the synthesized content. Each knowledge unit may represent a chunk of information that covers one or more related subjects. The knowledge units can be of varying sizes. For example, each knowledge unit may correspond to a portion of a data file (e.g., a section of a document) or to an entire data file (e.g., an entire document, an image, etc.). In some embodiments, multiple portions of data files or multiple data files can also be merged to generate a knowledge unit. By way of example, if an entire document is focused on a particular subject, a knowledge unit corresponding to the entire document can be generated. If different sections of a document are focused on different subjects, then different knowledge units can be generated from the different sections of the document. A single document may also result in both a knowledge unit generated for the entire document as well as knowledge units generated from portions of the document. As another example, various email threads relating to a common subject can be merged into a knowledge unit. The generated knowledge units are then indexed and stored in a searchable knowledge bank.

At block 208, content analysis is performed on the knowledge units. The content analysis may include performing semantics and linguistics analyses and/or contextual analysis on the knowledge units to infer concepts and topics covered by the knowledge units. Key terms (e.g., keywords and key phrases) can be extracted, and each knowledge unit can be associated with a term vector of key terms representing the content of the knowledge unit. In some embodiments, named entities can be identified from the extracted key terms. Examples of named entities may include place names, people's names, phone numbers, social security numbers, business names, dates and time values, etc. Knowledge units covering similar concepts can be clustered, categorized, and tagged as pertaining to a particular topic or topics. Taxonomy generation can also be performed to derive a corporate dictionary identifying key terms and how the key terms are used within an enterprise.

At block 210, knowledge packs are generated from individual knowledge units. The knowledge packs can be automatically generated by combining knowledge units based on similarity mapping of key terms, topics, concepts, metadata such as authors, etc. In some embodiments, a knowledge publisher can also access the knowledge units generated at block 206 to build custom knowledge packs. A knowledge map representing relationships between the knowledge packs can also be generated to provide a graphical representation of the knowledge corpus in an enterprise.

At block 212, the generated knowledge packs are mapped to knowledge consumers who are likely to be interested in the particular knowledge packs. This mapping can be performed based on information about the user (e.g., user's title, job function, etc.), as well as learned behavior of the user interacting with the system (e.g., knowledge packs that the user has viewed and consumed in the past, etc.). The user mapping can also take into account user feedback (e.g., adjusting relative interest levels, search queries, ratings, etc.) to tailor future results for the user. Knowledge packs mapped to a particular knowledge consumer can be distributed to the knowledge consumer by presenting the knowledge packs on a recommendations page for the knowledge consumer.

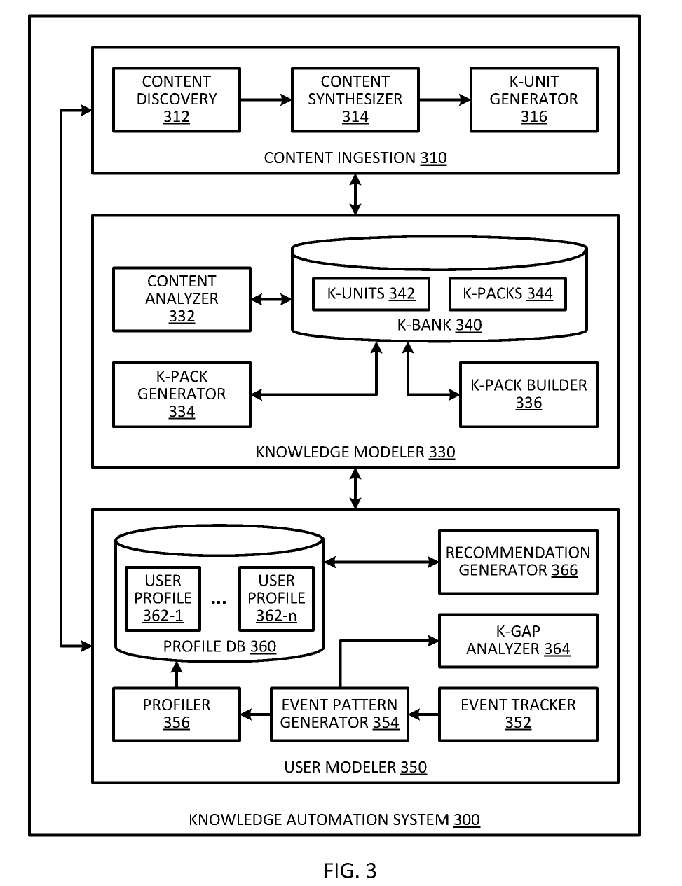

FIG. 3 illustrates a more detailed block diagram of a knowledge automation system 300, according to some embodiments. Knowledge automation system 300 can be implemented as a data processing system, and may include a content ingestion module 310, a knowledge modeler 330, and a user modeler 350. In some embodiments, the processes performed by knowledge automation system 300 can be performed in real-time. For example, as the data content or knowledge corpus available to the knowledge automation system changes, knowledge automation system 300 may react in real-time and adapt its services to reflect the modified knowledge corpus.

Content ingestion module 310 may include a content discovery module 312, a content synthesizer 314, and a knowledge unit generator 316. Content discovery module 312 interfaces with one or more content sources to discover contents stored at the content sources, and to retrieve the content for analysis. In some embodiments, knowledge automation system 300 can be deployed to an enterprise that already has a pre-existing content library. In such scenarios, content discovery module 312 can crawl or mine the content library for existing data files, and retrieve the data files for ingestion. In some embodiments, the content sources can be continuously monitored to detect the addition, removal, and/or updating of content. When new content is added to a content source or a pre-existing content is updated or modified, content discovery module 312 may retrieve the new or updated content for analysis. New content may result in new knowledge units being generated, and updated content may result in modifications being made to affected knowledge units and/or new knowledge units being generated. When content is removed from a content source, content discovery module 312 may identify the knowledge units that were derived from the removed content, and either remove the affected knowledge units from the knowledge bank, or tag the affected knowledge units as being potentially invalid or outdated.

Content synthesizer 314 receives content retrieved by content discovery module 312, and synthesizes the content to extract information contained in the content. The content retrieved by content discovery module 312 may include different types of content having different formats, storage requirements, etc. As such, content synthesizer 314 may convert the content into a common format for analysis. Content synthesizer 314 may identify key terms (e.g., keywords and/or key phrases) in the content, determine a frequency of occurrence of the key terms in the content, and determining locations of the key terms in the content. In addition to analyzing information contained in the content, content synthesizer 314 may also extract metadata associated with the content (e.g., author, creation date, title, revision history, etc.).

Knowledge unit generator 314 may then generate knowledge units from the content based on patterns of key terms used in the content and the metadata associated with the content. For example, if a document has a large frequency of occurrence of a key term in the first three paragraphs of the document, but a much lower frequency of occurrence of that same key term in the remaining portions of the document, the first three paragraphs of the document can be extracted and formed into a knowledge unit. As another example, if there is a large frequency of occurrence of a key term distributed throughout a document, the entire document can be formed into a knowledge unit. The generated knowledge units are stored in a knowledge bank 340, and indexed based on the identified key terms and metadata to make the knowledge units searchable in knowledge bank 340.

Knowledge modeler 330 may include content analyzer 332, knowledge bank 340, knowledge pack generator 334, and knowledge pack builder 336. Content analyzer 332 may perform various types of analyses on the knowledge units to model the knowledge contained in the knowledge units. For example, content analyzer 332 may perform key term extraction and entity (e.g., names, companies, organizations, etc.) extraction on the knowledge units, and build a taxonomy of key terms and entities representing how the key terms and entities are used in the knowledge units. Content analyzer 332 may also perform contextual, semantic, and linguistic analyses on the knowledge units to infer concepts and topics covered by the knowledge units. For example, natural language processing can be performed on the knowledge units to derive concepts and topics covered by the knowledge units. Based on the various analyses, content analyzer 332 may derive a term vector for each knowledge unit to represent the knowledge contained in each knowledge unit. The term vector for a knowledge unit may include key terms, entities, and dates associated with the knowledge unit, topic and concepts associated with the knowledge unit, and/or other metadata such as authors associated with the knowledge unit. Using the term vectors, content analyzer 332 may perform similarity mapping between the knowledge units to identify knowledge units that cover similar topics or concepts.

Knowledge pack generator 334 may analyze the similarity mapping performed by content analyzer 332, and automatically form knowledge packs by combining similar knowledge units. For example, knowledge units that share at least five common key terms can be combined to form a knowledge pack. As another example, knowledge units covering the same topic can be combined to form a knowledge pack. In some embodiments, a knowledge pack may include other knowledge packs, or a combination of knowledge pack(s) and knowledge unit(s). For example, knowledge packs that are viewed and consumed by the a set of users can be combined into a knowledge pack. The generated knowledge packs can be tagged with their own term vectors to represent the knowledge contain in the knowledge pack, and be stored in knowledge bank 340.

Knowledge pack builder 336 may provide a user interface to allow knowledge publishers to create custom knowledge packs. Knowledge pack builder 336 may present a list of available knowledge units to a knowledge publisher to allow the knowledge publisher to select specific knowledge units to include in a knowledge pack. In this manner, a knowledge publisher can create a knowledge pack targeted to specific knowledge consumers. For example, a technical trainer can create a custom knowledge pack containing knowledge units covering specific new features of a produce to train a technical support staff. The custom knowledge packs can also be tagged and stored in knowledge bank 340.

Knowledge bank 340 is used for storing knowledge units 342 and knowledge packs 344. Knowledge bank 340 can be implemented as one or more data stores. Although knowledge bank 340 is shown as being local to knowledge automation system 300, in some embodiments, knowledge bank 340, or part of knowledge bank 340 can be remote to knowledge automation system 300. In some embodiments, frequently requested, or otherwise highly active or valuable knowledge units and/or knowledge packs, can be maintained in in a low latency, multiple redundancy data store. This makes the knowledge units and/or knowledge packs quickly available when requested by a user. Infrequently accessed knowledge units and/or knowledge packs may be stored separately in slower storage.

Each knowledge unit and knowledge pack can be assigned an identifier that is used to identify and access the knowledge unit or knowledge pack. In some embodiments, to reduce memory usage, instead of storing the actual content of each knowledge unit in knowledge bank 340, the knowledge unit identifier referencing the knowledge unit and the location of the content source of the content associated with the knowledge unit can be stored. In this manner, when a knowledge unit is accessed, the content associated with the knowledge unit can be retrieved from the corresponding content source. For a knowledge pack, an knowledge pack identifier referencing the knowledge pack, and the identifiers and locations of the knowledge units and/or knowledge packs that make up the knowledge pack can be stored. Thus, a particular knowledge pack can be thought of as a container or a wrapper object for the knowledge units and/or knowledge packs that make up the particular knowledge pack. In some embodiments, knowledge bank 340 may also store the actual content of the knowledge units, for example, in a common data format. In some embodiments, knowledge bank 340 may selectively store some content while not storing other content (e.g., content of new or frequently accessed knowledge units can be stored, whereas stale or less frequently accessed content are not stored in knowledge bank 340).

Knowledge units 342 can be indexed in knowledge bank 340 according to key terms contained in the knowledge unit (e.g., may include key words, key phrases, entities, dates, etc. and number of occurrences of such in the knowledge unit) and/or associated metadata (e.g., author, location such as URL or identifier of the content, date, language, subject, title, file or document type, etc.). In some embodiments, the metadata associated with a knowledge unit may also include metadata derived by knowledge automation system 300. For example, this may include information such as access control information (e.g., which user or user group can view the knowledge unit), topics and concepts covered by the knowledge unit, knowledge consumers who have viewed and consumed the knowledge unit, knowledge packs that the knowledge unit is part of, time and frequency of access, etc.). Knowledge packs 344 stored in knowledge bank may include knowledge packs automatically generated by the system, and/or custom knowledge packs created by users (e.g., knowledge publishers). Knowledge packs 344 may also be indexed in a similar manner as for knowledge packs described above. In some embodiments, the metadata for a knowledge pack may include additional information that a knowledge unit may not have. For example, these may include a category type (e.g., newsletter, emailer, training material, etc.), editors, target audience, etc.

In some embodiments, a term vector can be associated with each knowledge element (e.g., a knowledge unit and/or a knowledge pack). The term vector may include key terms, metadata, and derived metadata associated with the each knowledge element. In some embodiments, instead of including all key terms present in a knowledge element, the term vector may include a predetermined number of key terms with the highest occurrence count in the knowledge element (e.g., the top five key terms in the knowledge element, etc.), or key terms that have greater than a minimum number of occurrences (e.g., key terms that appear more than ten times in a knowledge element, etc.).

User modeler 350 may include an event tracker 352, an event pattern generator 354, a profiler 356, a knowledge gap analyzer 364, a recommendations generator 366, and a profile database 360 that stores a user profile for each user of knowledge automation system 300. Event tracker 352 monitors user activities and interactions with knowledge automation system 300. For example, the user activities and interactions may include knowledge consumption information such as which knowledge unit or knowledge pack that a user has viewed, the length of time spent on the knowledge unit/pack, and when did the user access the knowledge unit/pack. The user activities and interactions tracked by event tracker 352 may also include search queries performed by the users, and user responses to the search results (e.g., number and frequency of similar searches performed by the same user and by other users, amount of time a user spends on reviewing the search result, how deep into a result list the user traversed, the number of items in the result list the user accessed and length of time spend on each item, etc.). If a user is a knowledge publisher, event tracker 352 may also track the frequency that the knowledge publisher publishes, when the knowledge publisher publishes, and topics or categories that the knowledge publisher publishes in, etc.

Event pattern generator 354 may analyze the user activities and interactions tracked by event tracker 352, and derive usage or event patterns for users or user groups. Profiler 356 may analyze these patterns and augment the user profiles stored in profile database 360. For example, if a user has a recent history of accessing a large number of knowledge packs relating to a particular topic, profiler 356 may augment the user profile of this user with an indication that this user has an interest in the particular topic. For patterns relating to search queries, knowledge gap analyzer 364 may analyze the search query patterns and identify potential knowledge gaps relating to certain topics in which useful information may be lacking in the knowledge corpus. Knowledge gap analyzer 364 may also identify potential content sources to fill the identified knowledge gaps. For example, a potential content source that may fill a knowledge gap can be a knowledge publisher who frequently publishes in a related topic, the Internet, or some other source from which information pertaining to the knowledge gap topic can be obtained.

Recommendations generator 366 may provide a knowledge mapping service that provides knowledge pack recommendations to knowledge consumers of knowledge automation system 300. Recommendations generator 366 may compare the user profile of a user with the available knowledge packs in knowledge bank 340, and based on the interests of the user, recommend knowledge packs to the user that may be relevant for the user. For example, when a new product is released and a product training knowledge pack is published for the new product, recommendations generator 366 may identify knowledge consumers who are part of a sales team, and recommend the product training knowledge pack to those users. In some embodiments, recommendations generator 366 may generate user signatures form the user profiles and knowledge signatures from the knowledge elements (e.g., knowledge units and/or knowledge packs), and make recommendations based on comparisons of the user signatures to the knowledge signatures. The analysis can be performed by recommendations generator 366, for example, when a new knowledge pack is published, when a new user is added, and/or when the user profile of a user changes.

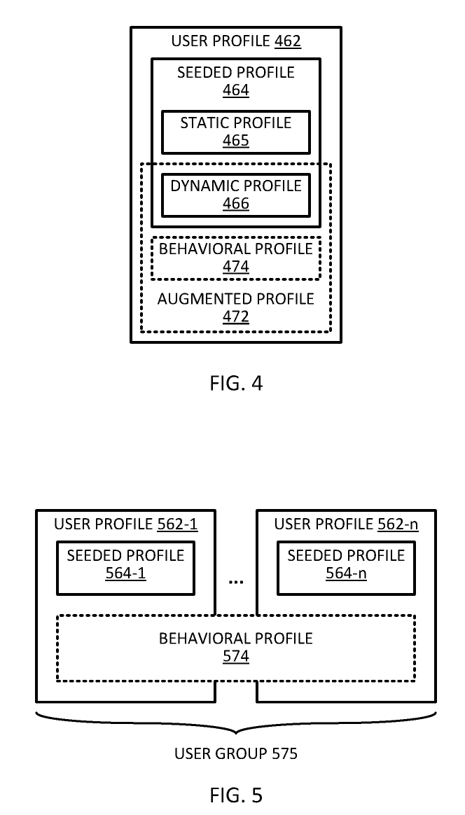

FIG. 4 illustrates a user profile 462 associated with a user of a knowledge automation system, according to some embodiments. User profile 462 can be stored, for example, in a user profile database. User profile 462 may include a seeded profile 464, and an augmented profile 472. Seeded profile 464 may include information about the user that is seeded or provided to the system when the user enrolls or registers in the knowledge automation system. For example, seeded profile 464 may include information such as the name of the user, the location and/or time zone of the user, role and/or job function of the user, work group the user is part of, experience of the user, expertise of the user, etc. Seeded profile 464 may include a static profile 465 that is generally static and does not change often for a user. For example, information such as name, location and/or time zone, and role and/or job function, etc. may be part of the static profile 465. Seeded profile 464 may also include a dynamic profile 466 that includes seeded information about a user that may change over time. For example, information such as work group, experience, and expertise, etc. can be part of dynamic profile 466, because the user's experience and expertise may grow over time, and the user can be placed on different teams over time.

Augmented profile 472 may include information about the user that the knowledge automation system modifies or adds to user profile 462. Augmented profile 472 may include information about the user that the knowledge automation system learns over time via monitoring of the user's activities and interactions with the system. Augmented profile 472 may include dynamic profile 466 that overlaps with seeded profile 464. For example, if the user has been consuming a large amount of knowledge about a particular topic, the knowledge automation system may add that topic to the user's seeded expertise. As another example, as the user completes one project and is placed on a different project team, the knowledge automation system may modify the seeded work group of the user to reflect this change.

Augmented profile 472 also includes behavioral profile 474 that represents the user's usage patterns in the knowledge automation system. For example, behavioral profile 474 may include information such as topics and/or publishers of knowledge packs that the user consumes, categories of knowledge packs that the user consumes, key terms that the user searches for, topics of knowledge packs that the user publishes, etc. Based on the user's activities and interactions with the system, the knowledge automation system may infer specific topics that the user may be interested in. In some embodiments, the user may be allowed to adjust the user's interest level of the topics that the knowledge automation system inferred, and this information can be included in behavioral profile 474.

In some embodiments, the knowledge automation system may group multiple users into a user group. A user group can be formed based on common attributes of the users. For example, users in the same work group can be formed into a user group, or users at the same location or time zone can be formed into a user group, etc. In some embodiments, a user group can be formed based on common behaviors of the users. For example, if a set of users often consumes knowledge packs on a particular topic, these users can be formed into a user group. As another example, if a set of users often publishes a particular category of knowledge packs, these users can be formed into a user group. It should be understood that a user can belong to more than one user group.

FIG. 5 illustrates user profiles of users belonging to a user group 575, according to some embodiments. User group 575 may include any number of users, and may include a user associated with user profile 562-1, and a user associated with user profile 562-n. User profiles 562-1 and 562-n may have respective seeded profiles 564-1 and 564-n. In some embodiments, because these users are part of the same user group 575, the knowledge automation system may augment user profiles 562-1 and 562-n with a group behavioral profile 574 across the entire user group based on the behaviors of members in the groups. For example, if knowledge automation system determines that a large number of members in user group 575 are interested in mobile device security, even though the user associated with user profile 562-1 may not have shown an interest in this topic, user profile 562-1 (as well as other user profiles of members in the group) may nevertheless be augmented to include mobile device security as a topic that the user may be interested in, because the user is part of user group 575. In this manner, the behaviors of members in a user group can be inferred to other members in the same user group. This allows the knowledge automation system to make knowledge recommendations to a user based on the not just the activities and interactions of that particular user alone, but also based on the activities and interactions of other users who are similar to that particular user.

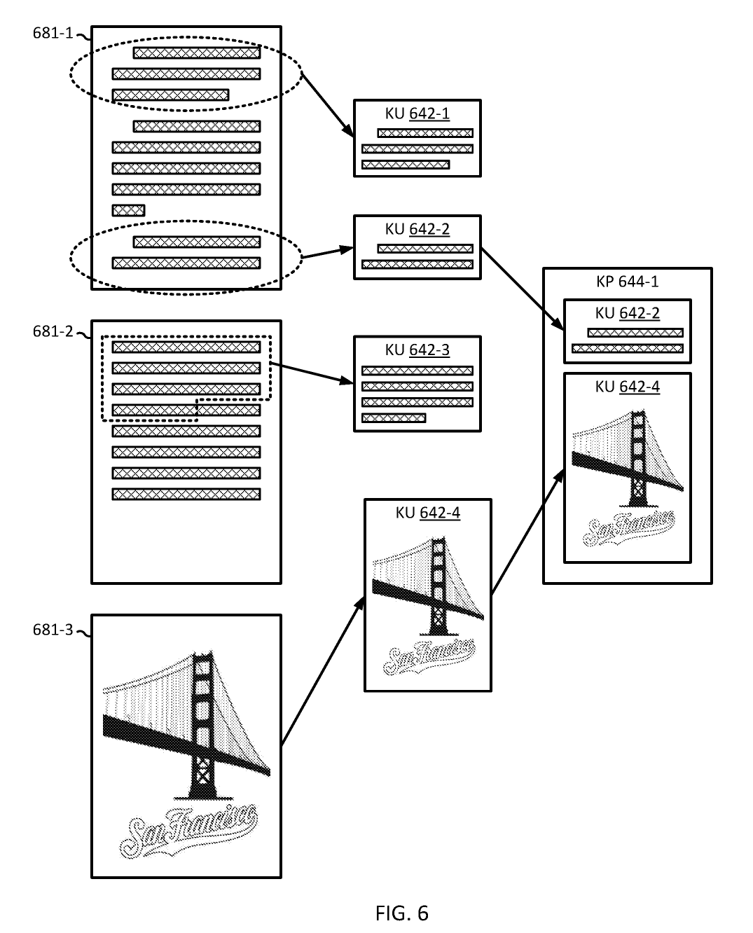

FIG. 6 illustrates an example formation of a knowledge pack from data content, according to some embodiments. In the example shown in FIG. 6, the data content discovered by the knowledge automation system may include a structured text file 681-1, an unstructured text file 681-2, and an image file 681-3.

Structured text file 681-1 can be parsed and analyzed based in part on the organization and structure of the document. For example, structured text file 681-1 may be organized into three paragraphs. The knowledge automation system may analyze structured text file 681-1, and determine that the first paragraph pertains to information about the state of California, the second paragraph discusses major cities on the west coast, and the third paragraph pertains to information about the city of San Francisco. This determination can be made, for example, based on a high frequency count of the key term “California” appearing in the first paragraph, various city names appearing in the second paragraph, and a high frequency count of the key term “San Francisco” appearing in the third paragraph. Based on this analysis, the knowledge automation system may segment structured text document 681-1 into individual paragraphs, and form a knowledge unit 642-1 directed to “California” from the first paragraph, and a knowledge unit 642-2 directed to “San Francisco” from the third paragraph.

Unstructured text file 681-2 may include a text blob without any apparent organization or structure in the document. The knowledge automation system may perform key term analysis on unstructured text file 681-2, and determine that the first portion of the document includes a high frequency count of the key term “California,” whereas the second portion of the document does not have any repeated key words or key phrases. Based on this analysis, the knowledge automation system may extract the first portion where the key term “California” appears repeatedly, and form a knowledge unit 642-3 directed to “California” from the first portion of unstructured text file 681-2.

Image file 681-3 may include a picture of the word “San Francisco.” The knowledge automation system may perform optical character recognition on image file 681-3, and extract the key term “San Francisco” from the picture. Based on this analysis, the knowledge automation system may form a knowledge unit 642-4 directed to “San Francisco” from image file 681-3.

Having generated knowledge units 642-1, 642-2, 642-3, and 642-4, the knowledge automation system may analyze the available knowledge units, and form knowledge packs by combining knowledge units directed to similar topics. For example, the knowledge automation system may form a knowledge pack 644-1 directed to the topic “San Francisco” by combining knowledge unit 642-2 and knowledge unit 642-4, which the knowledge automation system has tagged as being related to the topic “San Francisco.”

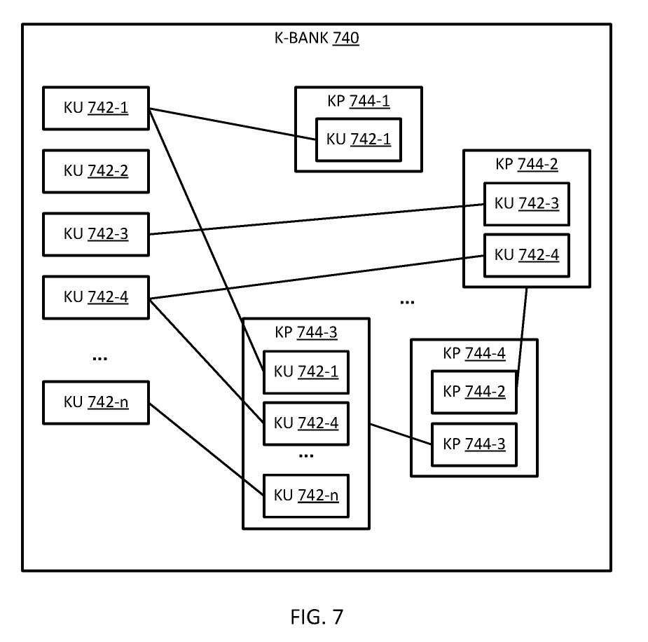

FIG. 7 illustrates a conceptual diagram of an example of the contents in a knowledge bank 740, according to some embodiments. Knowledge bank 740 may store the knowledge corpus of the knowledge automation system, and may include knowledge units 741-1 to 741-n. Knowledge units 741-1 to 741-n can be generated by the knowledge automation system from data content available in one or more content sources using the content discovery and ingestion techniques described herein. Based on the similarity mapping between knowledge units 741-1 to 741-n, or based on a input from knowledge publishers, knowledge packs 744-1 to 744-4 can be formed. For example, knowledge pack 744-1 can be generated from a single knowledge unit 742-1. Knowledge pack 744-2 can be generated by combining knowledge units 742-3 and 742-4. Knowledge pack 744-3 can be generated by combining knowledge units 742-1 and 742-4 to 742-n. Knowledge pack 744-4 can be generated by combining knowledge packs 744-2 and 744-3.

As this example illustrates, a single knowledge unit (e.g., knowledge unit 742-1) can be part of multiple knowledge packs (e.g., knowledge packs 744-1 and 744-3). A knowledge pack (e.g., knowledge pack 744-1) may include a single knowledge unit (e.g., knowledge unit 742-1). A knowledge pack (e.g., knowledge pack 744-2) may also include more than one knowledge unit (e.g., knowledge units 742-3 and 742-4). A knowledge pack (e.g., knowledge pack 744-4) may include other knowledge packs (e.g., knowledge packs 744-2 and 744-3). In some embodiments, a knowledge pack may also include a combination of one or more knowledge units and one or more knowledge packs.

### II. Content Discovery, Ingestion, and Analyses

Data content can come in many different forms. For example, data content (may be referred to as “data files”) can be in the form of text files, spreadsheet files, presentation files, image files, media files (e.g., audio files, video files, etc.), data record files, communication files (e.g., emails, voicemails, etc.), design files (e.g., computer aided design files, electronic design automation files, etc.), webpages, information or data management files, source code files, and the like. With the vast amount of data content that may be available to a user, finding the right data files with content that matters for the user can be challenging. A user may search an enterprise repository for data files pertaining to a particular topic. However, the search may return a large number of data files, where meaningful content for the user may be distributed across different data files, and some of the data files included in the search result may be of little relevance. For example, a data file that mentions a topic once may be included in the search result, but the content in the data file may have little to do with searched topic. As a result, a user may have to review a large number of data files to find useful content to fills the user's needs.

A knowledge modeling system according to some embodiments can be used to discover and assemble data content from different content sources, and organize the data content into packages for user consumption. Data content can be discovered from different repositories, and data content in different formats can be converted into a normalized common format for consumption. In some embodiments, data content discovered by the knowledge automation system can be separated into individual renderable portions. Each portion of data content can be referred to as a knowledge unit, and stored in a knowledge bank. In some embodiments, each knowledge unit can be associated with information about the knowledge unit, such as key terms representing the content in the knowledge unit, and metadata such as content properties, authors, timestamps, etc. Knowledge units that are related to each other (e.g., covering similar topics) can be combined together to form knowledge packs. By providing such knowledge packs to a user for consumption, the time and effort that a user spends on finding and reviewing data content can be reduced. Furthermore, the knowledge packs can be stored in the knowledge bank, and be provided to other users who may be interested in similar topics. Thus, the content discovery and ingestion for a fixed set of data content can be performed once, and may only need to be repeated if new data content is added, or if the existing data content is modified.

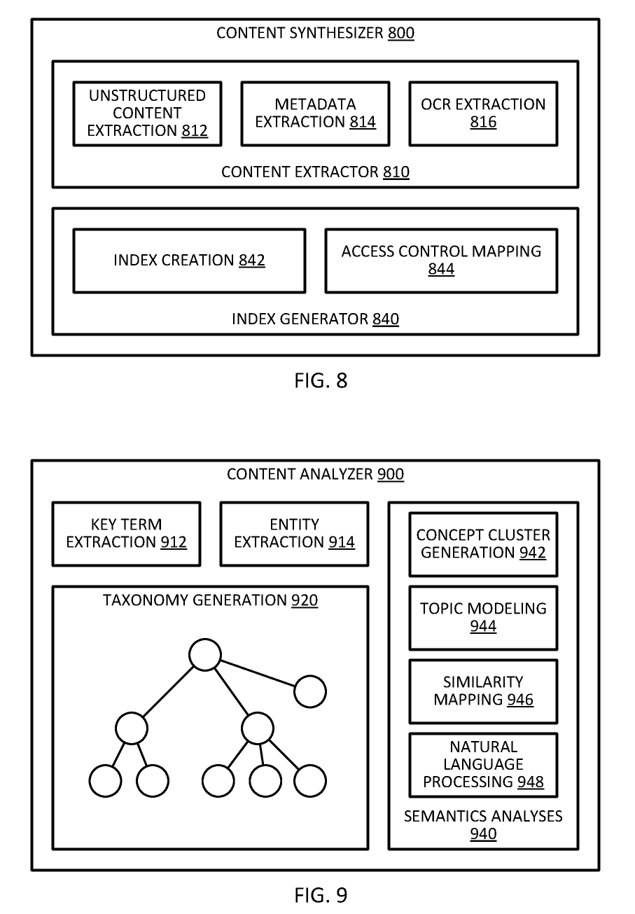

FIG. 8 illustrates a block diagram of a content synthesizer 800 that can be implemented in a knowledge automation system, according to some embodiments. Content synthesizer 800 can process content in discovered data files, and form knowledge units based on the information contained in the data files. A knowledge unit can be generated from the entire data file, from a portion of the data file, and/or a combination of different sequential and/or non-sequential portions of the data file. A data file may also result in multiple knowledge units being generated from that data file. For example, a knowledge unit can be generated from the entire data file, and multiple knowledge units can be generated from different portions or a combination of different portions of that same data file.

The data files provided to content synthesizer 800 can be discovered by crawling or mining one or more content repositories accessible to the knowledge automation system. Content synthesizer 800 may include a content extractor 810 and an index generator 840. Content extractor 810 can extract information from the data files, and organize the information into knowledge units. Index generator 840 is used to index the knowledge units according to extracted information.

Content extractor 810 may process data files in various different forms, and convert the data files into a common normalized format. For example, content extractor 810 may normalize all data files and convert them into a portable document format. If the data files include text in different languages, the languages can be translated into a common language (e.g., English). Data files such as text documents, spreadsheet documents, presentations, images, data records, etc. can be converted from their native format into the portable document format. For media files such as audio files, the audio can be transcribed and the transcription text can be converted into the portable document format. Video files can be converted into a series of images, and the images can be converted into the portable document format. If the data file include images, optical character recognition (OCR) extraction 816 can be performed on the images to extract text appearing in the images. In some embodiments, object recognition can also be performed on the images to identify objects depicted in the images.

In some embodiments, a data file may be in the form of an unstructured document that may include content that lacks organization or structure in the document (e.g., a text blob). In such cases, content extractor 810 may perform unstructured content extraction 812 to derive relationships of the information contained in the unstructured document. For example, content extractor 810 may identifying key terms used in the document (e.g., key words or key phrases that have multiple occurrences in the document), and the locations of the key terms in the document, and extract portions of the document that have a high concentration of certain key term. For example, if a key term is repeatedly used in the first thirty lines of the document, but does not appear or has a low frequency of occurrence in the remainder of the document, the first thirty lines of the document may be extracted from the document and formed into a separate knowledge unit.

For structured documents, a similar key term analysis can be performed. Furthermore, the organization and structure of the document can be taken into account. For example, different sections or paragraphs of the document having concentrations of different key terms can be extracted from the document and formed into separate knowledge segments, and knowledge units can be formed from the knowledge segments. Thus, for a structured document, how the document is segmented to form the knowledge units can be based in part on how the content is already partitioned in the document.

In addition to extracting information contained in the data files, content extractor 810 may also perform metadata extraction 814 to extract metadata associated with the data files. For example, metadata associated with a data file such as author, date, language, subject, title, file or document type, storage location, etc. can be extracted, and be associated with the knowledge units generated from the data file. This allows the metadata of a data file to be preserved and carried over to the knowledge units, for example, in cases where knowledge units are formed from portions of the data file.

Index generator 840 may perform index creation 842 and access control mapping 844 for the discovered data files and/or knowledge units generated therefrom. Index creation 842 may create, for each data file and/or knowledge unit, a count of the words and/or phrases appearing in the data file and/or knowledge unit (e.g., a frequency of occurrence). Index creation 842 may also associate each word and/or phrase with the location of the word and/or phrase in the data file and/or knowledge unit (e.g., an offset value representing the number of words between the beginning of the data file and the word or phrase of interest).

Access control mapping 844 may provide a mapping of which users or user groups may have access to a particular data file (e.g., read permission, write permission, etc.). In some embodiments, this mapping can be performed automatically based on the metadata associated with the data file or content in the data file. For example, if a document includes the word “confidential” in the document, access to the document can be limited to executives. In some embodiments, to provide finer granularity, access control mapping 844 can be performed on each knowledge unit. In some cases, a user may have access to a portion of a document, but not to other portions of the document.

FIG. 9 illustrates a block diagram of a content analyzer 900 that can be implemented in a knowledge automation system, according to some embodiments. Content analyzer 900 may analyze the generated knowledge units, and determine relationships between the knowledge units. Content analyzer 900 may perform key term extraction 912, entity extraction 914, taxonomy generation 920, and semantics analyses 940. In some embodiments, content analyzer 900 may derive a term vector representing the content in each knowledge unit based on the analysis, and associate the knowledge unit with the term vector.

Key term extraction 912 can be used to extract key terms (e.g., key words and/or key phrases) that appear in a knowledge unit, and determine the most frequently used key terms (e.g., top ten, twenty, etc.) in a knowledge unit. In some embodiments, key term extraction 912 may take into account semantics analyses performed on the knowledge unit. For example, pronouns appearing in a knowledge unit can be mapped back to the term substituted by the pronoun, and be counted as an occurrence of that term. In addition to extracting key terms, content analyzer 900 may also perform entity extraction 914 for entities appearing in or associated with the knowledge unit. Such entitles may include people, places, companies and organizations, authors or contributors of the knowledge unit, etc. In some embodiments, dates appearing in or associated with the knowledge unit can also be extracted. From this information, content analyzer 900 may derive a term vector for each knowledge unit to represent the content in each knowledge unit. For example, the term vector may include most frequently used key terms in the knowledge unit, entities and/or dates associated with the knowledge unit, and/or metadata associated with the knowledge unit.

Semantics analyses 940 performed on the knowledge units by content analyzer 900 may include concept cluster generation 942, topic modeling 944, similarity mapping 946, and natural language processing 948. Concept cluster generation 942 may identify concepts or topics covered by the knowledge units that are similar to each other, and cluster or group together the related concepts or topics. In some embodiments, concept cluster generation 942 may form a topic hierarchy of related concepts. For example, topics such as “teen smoking,” “tobacco industry,” and “lung cancer” can be organized as being under the broader topic of “smoking.”

Topic modeling 944 is used to identify key concepts and themes covered by each knowledge unit, and to derive concept labels for the knowledge units. In some embodiments, key terms that have a high frequency of occurrence (e.g., key terms appearing more than a predetermined threshold number such as key terms appearing more than a hundred times) can be used as the concept labels. In some embodiments, topic modeling 944 may derive concept labels contextually and semantically. For example, suppose the terms “airline” and “terminal” are used in a knowledge unit, but the terms do not appear next to each other in the knowledge unit. Topic modeling 944 may nevertheless determine that the “airline terminal” is a topic covered by the knowledge unit, and used this phrase as a concept label. A knowledge unit can be tagged with the concept or concepts that the knowledge unit covers, for example, by including one or more concept labels in the term vector for the knowledge unit.

Similarity mapping 946 can determine how similar a knowledge unit is to other knowledge units. In some embodiments, a knowledge unit distance metric can be used to make this determination. For example, the term vector associated with a knowledge unit can be modeled as a n-dimensional vector. Each key term or group of key terms can be modeled as a dimension. The frequency of occurrence for a key term or group of key terms can be modeled as another dimension. Concept or concepts covered by the knowledge unit can be modeled as a further dimension. Other metadata such as author or source of the knowledge unit can each be modeled as other dimensions, etc. Thus, each knowledge unit can be modeled as vector in n-dimensional space. The similarity between two knowledge units can then be determined by computing a Euclidean distance in n-dimensional space between the end points of the two vectors representing the two knowledge units. In some embodiments, certain dimensions may be weighted differently than other dimensions. For example, the dimension representing key terms in a knowledge unit can be weighted more heavily than the dimensions representing metadata in the Euclidean distance computation (e.g., by including a multiplication factor for the key term dimension in the Euclidean distance computation). In some embodiments, certain attributes of the knowledge unit (e.g., author, etc.) can also be masked such that the underlying attribute is not included in the Euclidean distance computation.

Natural language processing 948 may include linguistic and part-of-speech processing (e.g., verb versus noun, etc.) of the content and words used in the knowledge unit, and tagging of the words as such. Natural language processing 948 may provide context as to how a term is being used in the knowledge unit. For example, natural language processing 948 can be used to identify pronouns and the words or phrases being substituted by pronouns. Natural language processing 948 can also filter out article words such as “a” and “the” that content analyzer 900 may ignore. Different forms of a term (e.g., past tense, present tense, etc.) can also be normalized into its base term. Acronyms can also be converted into their expanded form.

In some embodiments, based on the extracted key terms and entities, and semantic analyses, content analyzer 900 may also perform taxonomy generation 920 to form a corporate dictionary. The taxonomy generation 920 may identify commonly used terms in the knowledge corpus, and how each term is used. For example, taxonomy generation 920 may link each term to snippets of the knowledge units that use the term. In some embodiments, taxonomy generation 920 may also create a hierarchy of related terms. For example, the term “smoking” may link to other terms such as “teen smoking,” “tobacco industry,” and “lung cancer” in the corporate dictionary.

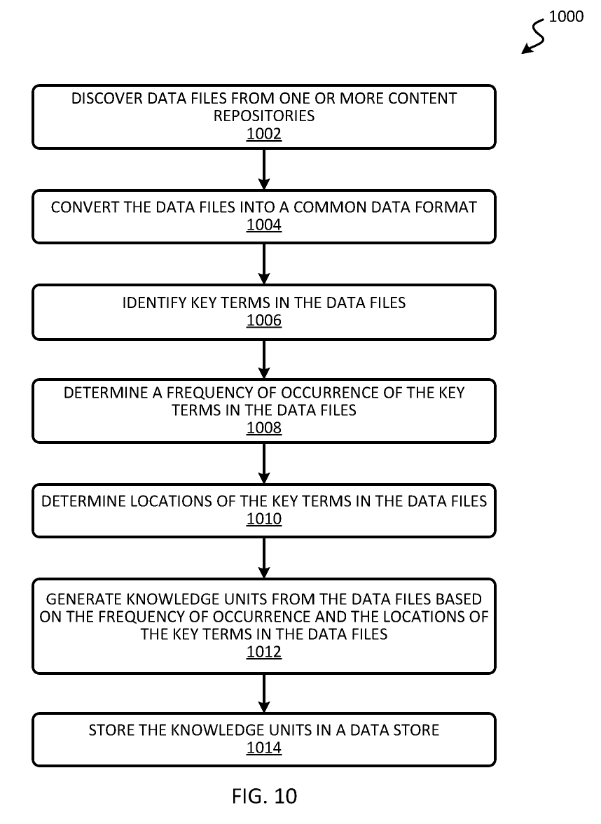

FIG. 10 illustrates a flow diagram of a content discovery and ingestion process 1000 that can be performed by a knowledge automation system, according to some embodiments. Process 1000 may begin at block 1002 by discovering data files from one or more content repositories. The data files can be discovered, for example, by crawling or mining one or more content repositories accessible by the knowledge automation system. In some embodiments, the data files can also be discovered by monitoring the one or more content repositories to detect addition of new content or modifications being made to content stored in the one or more content repositories.

At block 1004, the discovered data files can be converted into a common data format. For example, documents and images can be converted into a portable document format, and optical character recognition can be performed on the data files to identify text contained in the data files. Audio files can be transcribed, and the transaction text can be converted into the portable document format. Video files can also be converted into a series of images, and the series of images can be converted into the portable document format.

At block 1006, process 1000 may identify key terms in the discovered data files. A key term may be a key word or a key phrase. In some embodiments, a key term may refer to an entity such as a person, a company, an organization, etc. A word or a phrase can be identified as being a key term, for example, if that term is repeatedly used in the content of the data file. In some embodiments, a minimum threshold number of occurrences (e.g., five occurrences) can be set, and terms appearing in the data file more than the minimum threshold number of occurrences can be identified as a key term. In some embodiments, metadata associated with the data file can also be identified as a key term. For example, a word or a phrase in the title or the filename of the data file can be identified as a key term.

At block 1008, for each of the identified key terms, the frequency of occurrence of the key term in the corresponding data file is determined. The frequency of occurrence of the key term can be a count of the number of times the key term appears in the data file. In some embodiments, depending on where the key term appears in the data file, the occurrence of the key term can be given additional weight. For example, a key term appearing in the title of a data file can be counted as two occurrences. In some embodiments, pronouns or other words that are used as a substitute for a key term can be identified and correlated back to the key term to be included in the count.

At block 1010, for each of the identified key terms, the location of each occurrence of the key term is determined. In some embodiments, the location can be represented as an offset from the beginning of the document to where the key term appears. For example, the location can be represented as a word count from the beginning of the document to the occurrence of the key term. In some embodiments, page numbers, line numbers, paragraph numbers, column numbers, grid coordinates, etc., or any combination thereof can also be used.

At block 1012, process 1000 generates knowledge units from the data files based on the determined frequencies of occurrence and the determined locations of the key terms in the data files. In some embodiments, knowledge units can be generated for a predetermined number of the most frequently occurring key terms in the data file, or key terms with a frequency of occurrence above a predetermined threshold number in the data file. By way of example, the first and last occurrences of the key term can be determined, and the portion of the data file that includes the first and last occurrences of the key term can be extracted and formed into a knowledge unit. In some embodiments, a statistical analysis of the distribution of the key term in the data file can be used to extract the most relevant portions of the data file relating to the key term. For example, different portions of the data file having a concentration of the key term being above a threshold count can be extracted, and these different sections can be combined into a knowledge unit. The portions being combined into a knowledge unit may include sequential portions and/or non-sequential portions. Thus, a data file can be segmented into separate portions or knowledge segments, and one or more of the knowledge units can be formed by combining the different portions or knowledge segments. For a data file that includes unstructured content, and the data file can be segmented based on the locations of the occurrences of the key terms in the data file. For structured data files, the segmentation can be performed based on the organization of the data file (e.g., segment at the end of paragraphs, end of sections, etc.). It should be noted that in some embodiments, a knowledge unit can also be formed from an entire data file.

At block 1014, process 1000 may store the generated knowledge units in a data store (e.g., a knowledge bank). In some embodiments, each knowledge unit can be assigned a knowledge unit identifier that can be used to reference the knowledge unit in the data store. Each of the knowledge units can also be associated with a term vector that includes one or more key terms associated with the corresponding knowledge unit. Additional information that can be included in the term vector may include metadata such as author or source of the knowledge unit, location of where the knowledge unit is stored in the one or more content repositories, derived metadata such as the topic or topics associated with the knowledge unit, etc.

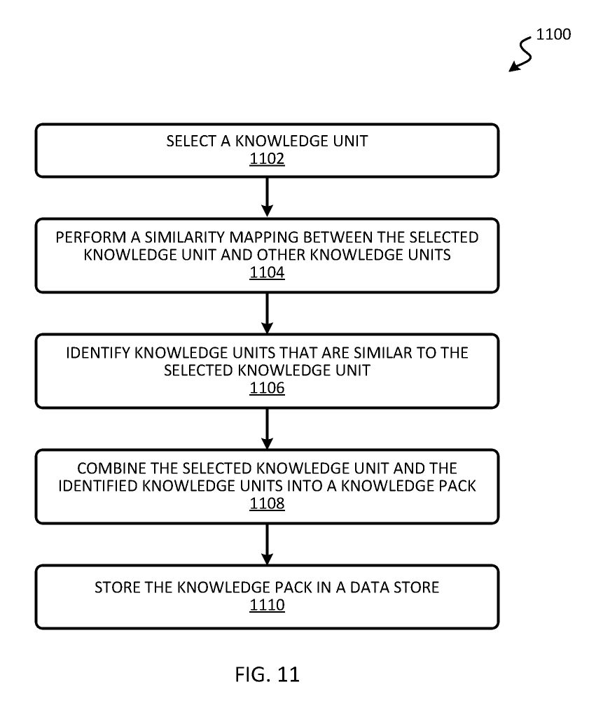

FIG. 11 illustrates a flow diagram of a content analysis process 1100 that can be performed by a knowledge automation system on the generated knowledge units, according to some embodiments. Process 1100 may begin at block 1102 by selecting a generated knowledge unit. The knowledge unit can be selected, for example, by an iterative process, randomly, or as a new knowledge unit is generated.

At block 1104, process 1100 performs a similarity mapping between the selected knowledge unit and the other knowledge units available in the knowledge bank. Process 1100 may use a knowledge unit distance metric, such as a Euclidean distance computation, to determine the amount of similarity between the knowledge units. By way of example, the term vector associated with each knowledge unit can be modeled as a n-dimensional vector, and the Euclidean distance in n-dimensional space between the end points of the vectors representing the knowledge units can be used to represent the amount of similarity between the knowledge units.

At block 1106, one or more knowledge units that are similar to the selected knowledge unit can be identified. For example, a knowledge unit can be identified as being similar to the selected knowledge unit if the knowledge unit distance metric (e.g., Euclidean distance) between that knowledge unit and the selected knowledge unit is below a predetermined threshold distance. In some embodiments, this threshold distance can be adjusted to adjust the number of similar knowledge units found.

At block 1108, the selected knowledge unit and the identified one or more similar knowledge units can be combined and formed into a knowledge pack. The knowledge pack can then be stored in a data store (e.g., a knowledge bank) at block 1110 for consumption by a knowledge consumer. In some embodiments, each knowledge pack can be assigned a knowledge pack identifier that can be used to reference the knowledge unit in the data store. Each of the knowledge packs can also be associated with a term vector that includes one or more key terms associated with the corresponding knowledge pack. In some embodiments, because a knowledge pack may have a large number of key terms, the key terms included in the knowledge pack term vector can be limited to a predetermined number of the most frequently occurring key terms (e.g., top twenty key terms, top fifty key terms, etc.). Additional information that can be included in the term vector may include metadata and derived metadata such as the topic or topics associated with the knowledge pack, a category that the knowledge pack belongs to, etc.

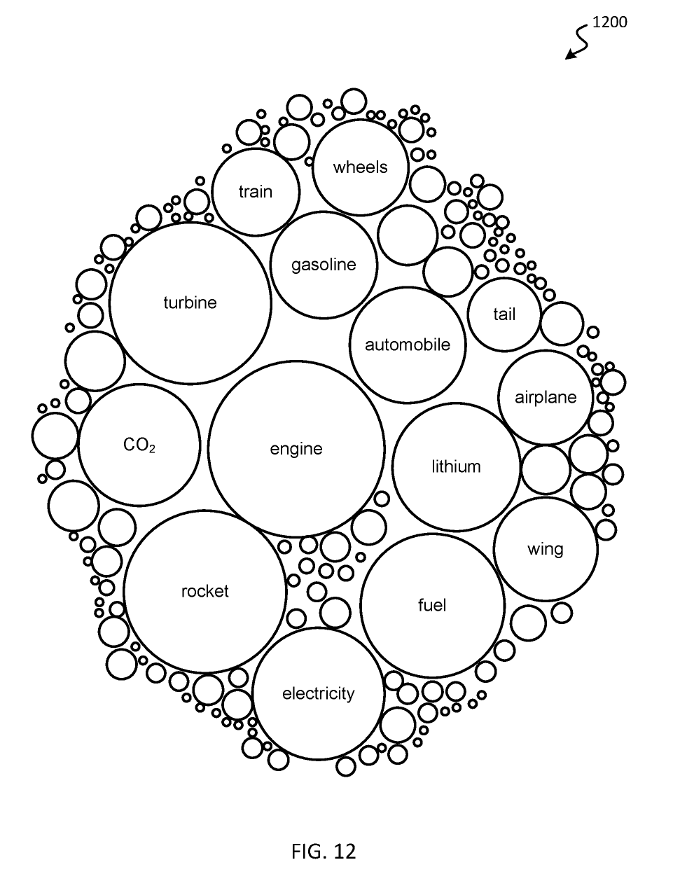

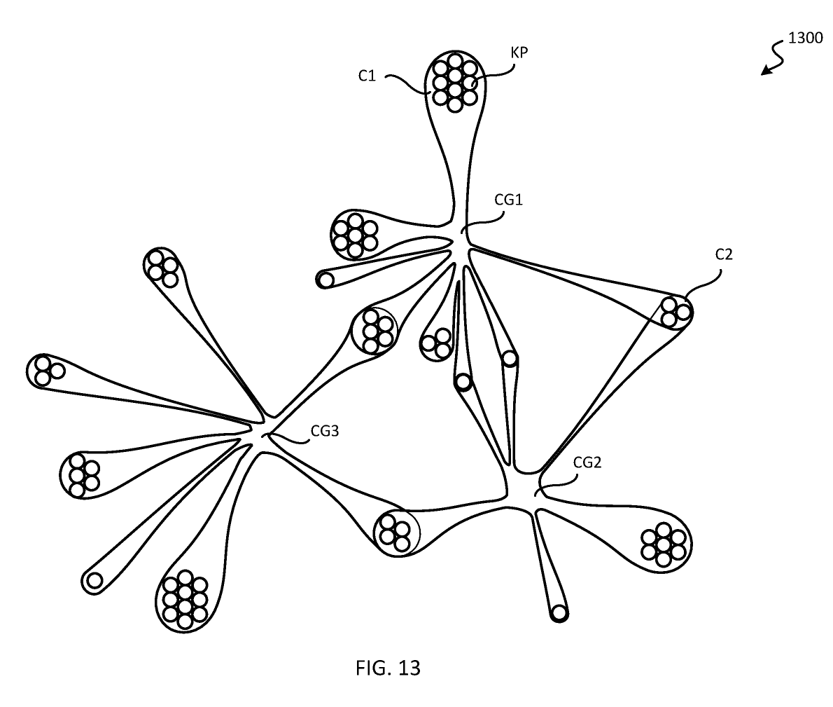

FIG. 12 illustrates an example of a graphical representation of the knowledge corpus of a knowledge automation system, according to some embodiments. The graphical representation shown in FIG. 12 may be referred to as a bubble chart 1200. Each circle or bubble in bubble chart 1200 can represent a key term or a topic that the knowledge automation system has identified. The size of the circle or bubble represents that amount of content available for each key term or topic. The knowledge automation system can generate bubble chart 1200, and display it on a graphical user interface for a user to view. In some embodiments, a user may refer to bubble chart 1200 to determine how much knowledge is available for each key term or topic.

FIG. 13 illustrates an example of a graphical representation of a knowledge map 1300 that can be generated by a knowledge automation system, according to some embodiments. A knowledge map can be displayed to a user to provide a graphical representation of relationships between knowledge available in a knowledge automation system. Each bubble on the knowledge map 1300 may represent a knowledge pack (e.g., KP). The knowledge pack bubbles are grouped together to form knowledge pack clusters (e.g., CC1, CC2) based on the conceptual similarities between the knowledge packs. Each knowledge pack cluster can be part of a concept group (e.g., CG1, CG2, CG3), or can be a standalone cluster. A concept group may correlate to a root topic, and each knowledge pack cluster may correlate to a subtopic. Knowledge map 1300 can represent how clusters of knowledge packs are similar or related to one another, and how the clusters may overlap with one another. For example, on the knowledge map 1300 shown in FIG. 13, concept group CG1 may correlate to the topic “smoking,” and concept group CG2 may correlate to the topic “cancer.” Knowledge group cluster C1 is a subtopic of concept group CG1. For example, knowledge group cluster C1 may correlate to the topic “teen smoking,” which is a subtopic of “smoking.” Knowledge group cluster C2 is a subtopic that overlaps with both concept groups CG1 and CG2. For example, knowledge group cluster C2 may correlate to the topic “lung cancer,” which is a subtopic of both “smoking” and “cancer.”

### III. Knowledge to User Mapping

In some embodiments, the knowledge automation system can provide a knowledge mapping service to automatically map knowledge consumers to relevant knowledge as new users and/or new knowledge are added to the system. The knowledge mapping service may also update the knowledge mappings dynamically, for example, by adding or removing knowledge consumers to accommodate changes in user roles or user behavior. In this manner, relevant knowledge can be provided to the right users at the right time, without requiring ongoing manual matching or curation. The automatic knowledge mapping service can also reduce the time required to get relevant information to users (e.g., by eliminating the need for a user to search manually for the relevant information). Additionally, by targeting knowledge that is most relevant to the knowledge consumer, the automatic knowledge mapping service can avoid overloading users with too much information, which may lead to users miss relevant knowledge even when it has been provided to them.

In some embodiments, the knowledge mapping can be performed using knowledge signatures and user signatures. The knowledge automation system can generate a knowledge signature for each knowledge element (e.g., knowledge unit or knowledge pack) in the system. In some embodiments, the term vector associated with a knowledge element can be used as the knowledge signature. The knowledge automation system can also generate a user signature for each knowledge consumer of the system. In some embodiments, the user signature can be based on user profile information such behavioral profile information about the user (e.g., information relating to user activities and interactions on the system such as knowledge that the knowledge consumer has or regularly consumes), and/or seeded profile information about the user (e.g., information provided when the user enrolls or registers for the system). Whenever a new knowledge pack is generated or published by a knowledge publisher, or whenever a knowledge unit is generated from new content added to the system, the knowledge automation system can automatically compare the knowledge signature of the new knowledge element to the user signatures of users of the system to determine matching knowledge consumers who may be interested in the new knowledge element.

In some embodiments, access control rules can be applied during knowledge mapping. For example, if a knowledge consumer is matched to a knowledge element, the system can determine whether the knowledge consumer belongs to a category or group of users that can have access to this knowledge element. If so, the knowledge element can be recommended to the knowledge consumer. However, if the user is restricted from consuming the knowledge element and access rights would be violated, then the knowledge element may not be recommended to the user.

In some embodiments, when a knowledge consumer is first added to the system, the knowledge consumer can be assigned a blank user signature. In some embodiments, seeded profile information (e.g., job function, work group, location, etc.) can be added to the user signature to generate an initial user signature. Additional information such as interests of the knowledge consumer can also be collect and be added as part of the initial user signature. As the knowledge consumer views and consumes knowledge packs and/or knowledge units, key terms from the consumed knowledge elements can be extracted and added to the user signature. In some embodiments, if the same key term is associated with multiple knowledge packs or knowledge units consumed by the knowledge consumer, then the weight for that key term can be correspondingly increased.

A knowledge consumer can potentially view many different knowledge elements overtime, which may result in lengthy user signatures. As such, in some embodiments, an optimization can be applied to the user signatures to maintain a predetermined number of top key terms (e.g., the top one hundred key terms), while discarding any remaining key terms. In some embodiments, the number of key terms in a user signature may vary based on the user's role, the user's employment history with the organization, or other user-specific metrics, etc.

The knowledge automation system may then apply a matching algorithm to the user signatures and knowledge signatures. For example, in some embodiments, a matching algorithm can be provided which increases a match score for each matching term appearing in both signatures, and one or more thresholds for match scores can be set to indicate whether a match between a knowledge consumer and the knowledge unit/pack has been found. In some embodiments, the match score thresholds may be adjusted to find fewer or more matches.

In some embodiments, the knowledge matching service can be enhanced through analysis of metadata associated with the knowledge elements (e.g., user comments, user ratings, etc.). For example, a knowledge element that is matched to a particular knowledge consumer may nevertheless be not recommended to the user if the user ratings for that knowledge element is low.

In some embodiments, a knowledge consumer may override the knowledge automation system and adjust the weight of a key term in the user signature. By adjusting the weight given to a key term, the knowledge consumer can adjust the interest level for that key term to refine and tailor the knowledge recommendations provided by the system. In some embodiments, user feedback can also be received regarding the relevance of recommendations provided through the automatic knowledge mapping. If a recommendation is relevant as indicated by the knowledge consumer, the knowledge matching algorithm can increase the weights for the key terms associated with the recommended knowledge element. If the knowledge consumer indicates that the recommended knowledge element is not relevant, the weights for those key terms can be reduced. This provides a feedback loop for refining future recommendations given by the system.

The knowledge recommendations provided by the knowledge mapping service can be provided to a user through a graphical user interface. For example, a list of knowledge recommendations can be displayed to the knowledge consumer, and can be arranged based on the freshness of the knowledge and the degree of match (e.g., newer knowledge elements and knowledge elements with higher degree of match can be displayed first).

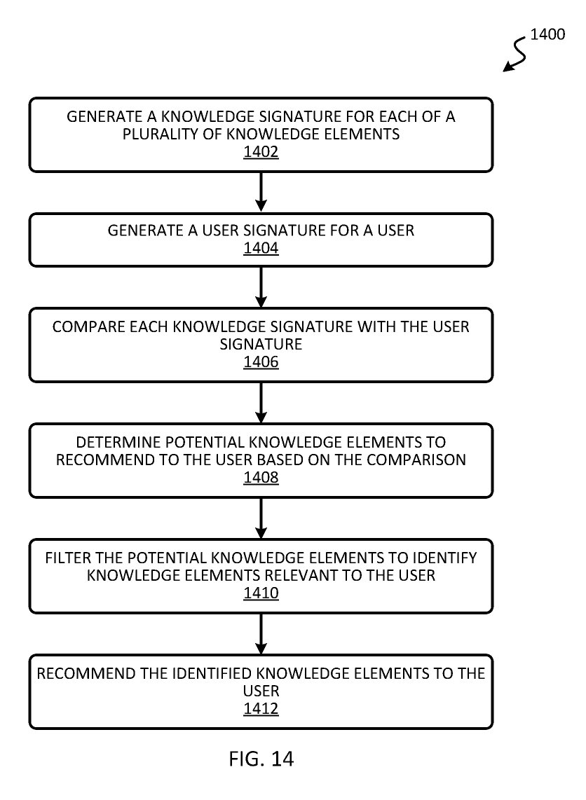

FIG. 14 illustrates a flow diagram of a knowledge mapping process 1400 that can be performed by a knowledge automation system, according to some embodiments. Process 1400 may begin at block 1402 by generating a knowledge signature for each knowledge elements (e.g., each knowledge unit and/or knowledge pack) available to the knowledge automation system. In some embodiments, a term vector associated with the knowledge element can be used as the knowledge signature.

At block 1404, a user signature is generated for a user (e.g., a knowledge consumer) of the knowledge automation system. The user signature can be generated based on the user profile of the user, and may include behavioral user profile information such as key terms of knowledge elements that the user has consumed, and authors or publishers of those knowledge elements. The user signature may also include seeded information such as the user's job function and role. The user signature may also include augmented profile information relating to activities of other users in the user group that the user belongs to (e.g., key terms of knowledge elements consumed by other users in the user group).

At block 1406, the knowledge signature of each knowledge element is compared with the user signature. The comparison can be based on a match score representing a count of common key terms appearing in both signatures. In some embodiments, certain key terms can be given more weight than other key terms (e.g., based on user adjustment of the interest level for the key term). At block 1408, potential knowledge elements to recommend to the user are determined based on the comparison performed at block 1406. For example, a knowledge element having a match score above a predetermined threshold score can be determined as a potential knowledge element to recommend to the user. In some embodiments, the threshold score can be adjusted to adjust the number of matches found.

At block 1410, the potential knowledge elements are filtered to identify knowledge elements that are most relevant or useful to the user. One or more filtering criteria can be used. For example, stale knowledge elements that are older than a certain age can be filtered out, and/or knowledge elements with user ratings or viewership less than a threshold amount can be filtered out. At block 1412, process 1400 recommends the identified knowledge elements that are most relevant to or useful to the user. For example, the knowledge automation system may display a list of the identified knowledge elements on a recommendations page of a graphical user interface for the user.

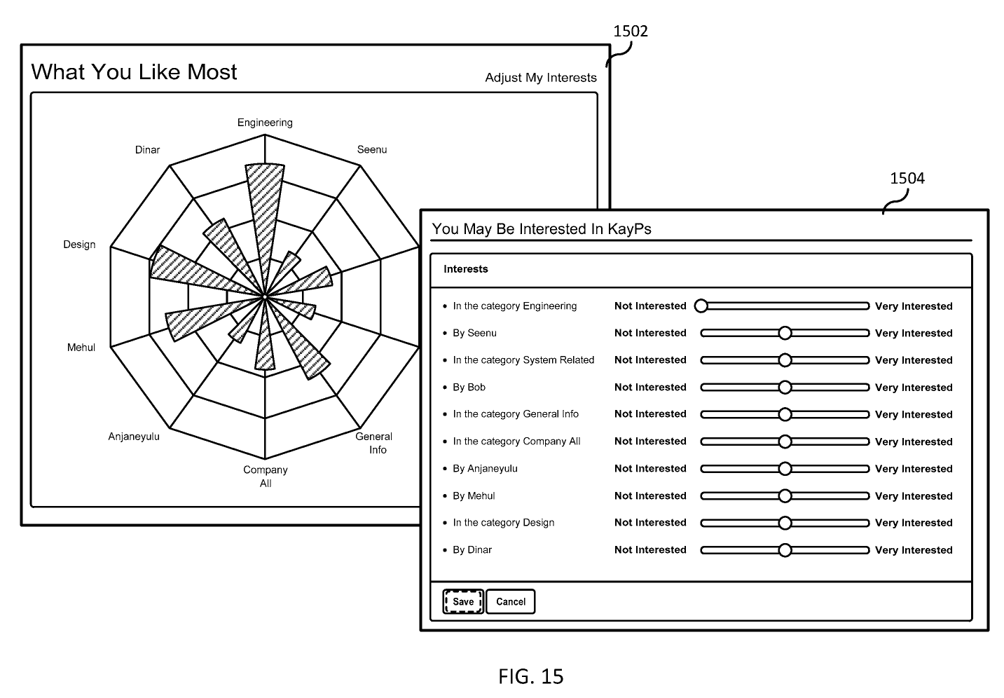

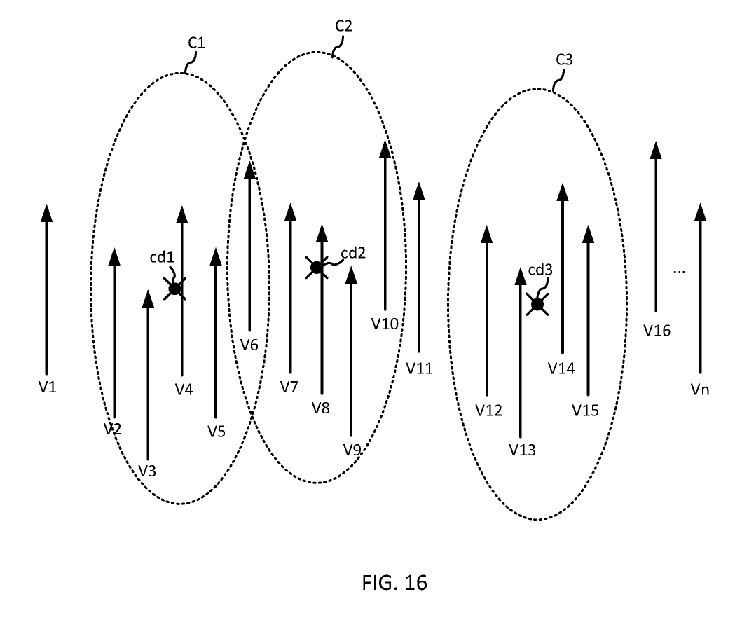

FIG. 15 illustrates a diagram of a user's interest level in identified content 1502 and a graphical user interface for adjusting the interest levels 1504, according to some embodiments. As shown in FIG. 15, user interests can be modeled based on the user's activity. For example, the knowledge automation system may determine a user's interest based on topics, categories, and/or key terms associated with knowledge elements that the user has consumed, and/or authors or publishers that are regularly followed by the user. For example, if the user accesses and views knowledge packs published by a certain knowledge publisher, the user model will reflect an interest in that publisher. Similarly, interests may be modeled based on categories of content. For example, if the user frequently accesses and consumes knowledge packs in the engineering category, then the user model will reflect an interest in engineering material. Knowledge elements consumed by a user may also be analyzed, e.g., based on key terms, to identify additional dimensions of interest for a user. In addition to automatically identifying a user's interests based on their user profile, a graphical user interface 1504 may be provided to the user to manually adjust their interest levels for interests of the user identified by the knowledge automation system. The sliders depicted in FIG. 15 allows a user may manually adjust their level of interest. The adjusted level of interest can be taken into account to improve the knowledge mapping performed by the knowledge automation system. For example, if the user adjusts the interest level of an interest to “Not Interested,” the weight of that key term used in the matching algorithm can be reduced or the key term be eliminated. If the user adjusts the interest level of an interest to “Very Interested,” the weight of that key term used in the matching algorithm can be increased.

According to some embodiments, the knowledge mapping service can also automatically map knowledge consumers to relevant knowledge based on a user vector clustering model. In such embodiments, a user vector can be generated for each user of the knowledge automation system. User vectors that are similar to each other can be grouped into a cluster, and knowledge elements that are popular for the users of a cluster can be associated with that cluster. The knowledge mapping service can be run at a periodic interval, for example, once a week, to map target users to relevant knowledge by matching the target user vector of a target user to a cluster. Once a matching cluster is determined, the knowledge elements associated with the matching cluster can be recommended to the target user.

FIG. 16 illustrates a conceptual diagram of grouping user vectors into clusters, according to some embodiments. Each of user vectors V1 to Vn is associated with a user of the knowledge automation system. Each user vector can be represented as a vector in N-dimensional Euclidean space, and the dimensionalities of the vector can represent user profile information of the user. For example, each user vector may include or represent information such as seeded profile information of the user, interaction data of the user's interactions with knowledge elements of the knowledge automation system, and/or knowledge element metadata of the knowledge elements that the user interacted with. Seeded profile information of the user may include a job function of the user, a role of the user, experience or expertise of the user, workgroup or department that the user belongs to, location of the user, gender of the user, age of the user, etc. Knowledge element metadata may include metadata that is extracted from knowledge elements that the user has interacted with (e.g., that the user has viewed). For example, knowledge element metadata may include key terms or phrases extracted from the knowledge element, title of the knowledge element, topics covered by the knowledge element, categories that the knowledge element belongs to, publisher of the knowledge element, a timestamp of when the knowledge element was published or last modified or last accessed, tags associated with the knowledge element, etc. Interaction data may include information about how the user interacted with a knowledge element. For example, interaction data may include viewership of a knowledge element, amount of time a user spent on a knowledge element, a timestamp of the most recent access of a knowledge element, publication of a knowledge element, modification made to a knowledge element, a comment made by the user on the knowledge element, a rating of the knowledge element, sharing of the knowledge element, etc.

User vectors that are similar to each other can be grouped into a cluster. In some embodiments, a clustering distance metric between the user vectors can be used to determine which user vectors are similar to each other. The clustering distance metric can be, for example, user vectors that are within a predetermined Euclidean distance of each other. For example, referring to FIG. 16, user vectors V2 to V6 can be grouped into a cluster C1 since these user vectors are within a predetermined Euclidean distance bound by the area spanned by C1. Similarly, user vectors V6 to V10 can be grouped into a cluster C2, and user vectors V12 to V15 can be grouped into a cluster C3. As illustrated by cluster C1 and C2, some user vectors such as user vector V6 can belong to more than one cluster. In some embodiments, some user vectors may not belong to any particular cluster.

In some embodiments, some or all of the user profile information represented by the user vector can be maskable when grouping the user vectors into clusters. For example, each type of user profile information (e.g., seeded profile information, interaction data, knowledge element metadata, etc.) can be maskable. In other words, in some embodiments, instead of taking into account all three types of user profile information when forming the cluster, one or more types of user profile information can be masked. Hence, in some embodiments, a cluster can be formed based on similarities of user vectors, for example, taking into account only the interaction data and knowledge element metadata of the user vectors. In some embodiments, each subtype of information under each type of user profile information can also be individual maskable (e.g., the location of user can be masked out when grouping the user vectors into clusters). The determination of which data type or subtype is masked out can be made, for example, by an administrator of the knowledge automation system, or by the individual users to tailor the knowledge recommendation results.

For each cluster that is formed, a centroid of the cluster can be determined. The centroid of a cluster can represent the center point of the user vectors belonging to each cluster, or can be determined, for example, by calculating a mean or average of the user vectors belonging to each cluster. Referring to FIG. 16, point cd1 can represent the centroid of cluster C1, point cd2 can represent the centroid of cluster C2, and point cd3 can represent the centroid of cluster C3. In some embodiments, the centroid of each cluster represented as a numeric value can be used as a cluster identifier for the corresponding cluster.

For each cluster that is formed, knowledge elements are also associated with the cluster. In some embodiments, the knowledge elements associated with a cluster can be represented as leaf nodes of the centroid of the cluster. The knowledge elements that are associated with a cluster may include knowledge elements that the users associated with the cluster has interacted with. In some embodiments, knowledge elements that are most popular with users of the cluster can be associated with the cluster. For example, the most popular knowledge elements (e.g., top ten, twenty, fifty knowledge elements, etc.) can be knowledge elements with the most viewership, most frequently accessed, most recently accessed by users of the cluster, and/or knowledge elements with the highest ratings.

Each cluster can then be represented as a key-value pair in the knowledge automation system. For example, the key of a cluster can be the cluster identifier, and the value associated with the cluster can be a list of knowledge element identifiers of the knowledge elements that are associated with the cluster (e.g., most popular knowledge elements). Thus, for example, cluster C1 can be represented in the knowledge automation system as the key-value pair (cd1; {k1, k2, k3, . . . , kn}), where cd1 is the centroid of C1, and k1 to kn are the knowledge element identifiers of the knowledge elements associated with cluster C1.

To provide a recommendation of knowledge elements to a target user, the knowledge mapping service can compare the target user vector of the target user with the centroids of the clusters to determine which clusters are closest to the target user vector. In some embodiments, a score representing how closely matched each cluster is to the target user vector can be determined, for example, by using a Euclidean distance between the centroid and the target user vector. Clusters with centroids having a score above a predetermined threshold score (or a distance below a predetermined threshold distance) can be deemed to be a matching cluster. In some embodiments, one or more types or subtypes of user profile information in the target use vector can be masked when comparing the target user vector to the centroids of the clusters.

Once a set of one or more matching clusters have been determined for the target user, one or more recommendations of knowledge elements associated with the matching clusters can be provided to the user. In some embodiments, the knowledge elements recommended to the target user can be determined by looking up the key-value pair associated with each matching cluster, and identifying the knowledge elements associated with the knowledge element identifiers in each retrieved key-value pair. In some embodiments, additional filtering can be performed to reduce the number of knowledge elements recommended to the target user. For example, knowledge elements associated with a matching cluster which the target user has already consumed can be filtered out. In some embodiments, knowledge elements that are stale (e.g., knowledge elements that have not been accessed for a predetermined elapsed time) and/or knowledge elements have a low rating (e.g., below a threshold rating) can also be filtered out. The knowledge elements recommended to the target user can be presented on a graphical user interface, for example, when the target user logs on to or accesses the knowledge automation system.

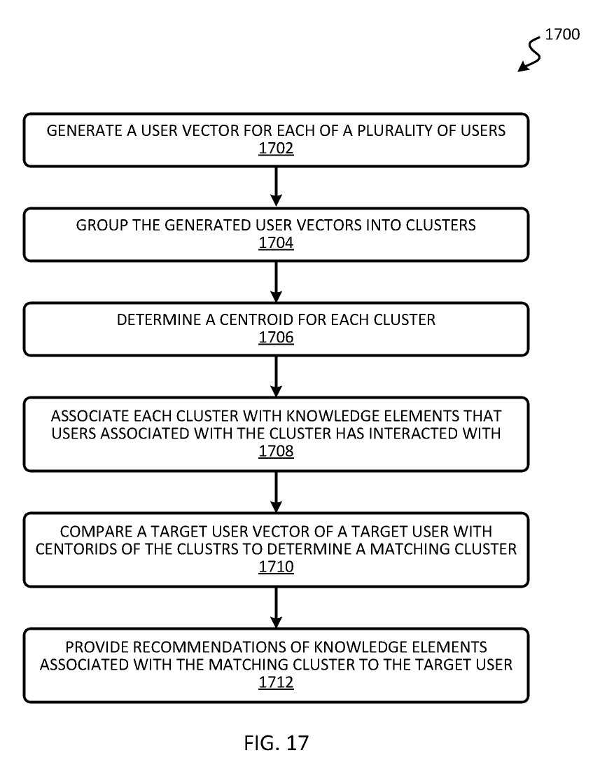

FIG. 17 illustrates a flow diagram of a knowledge mapping process 1700 that can be performed by a knowledge automation system, according to some embodiments. Process 1700 may begin at block 1702 by generating, for each user of a plurality of users of the knowledge automation system, a user vector associated with the user. In some embodiments, the user vector may include different types of user profile information including seeded profile information of the user, interaction data of user interactions with knowledge elements of the data processing system, and/or knowledge element metadata of the knowledge elements that the user interacted with.

Examples of seeded profile information of the user may include one or more of a job junction of the user, a role of the user, an expertise of the user, an age of the user, a location of the user, and a gender of the user, etc. Examples of user interactions between the user and a knowledge element may include one or more of viewing the knowledge element, commenting on the knowledge element, rating of the knowledge element, sharing of the knowledge element, and publishing of the knowledge element performed by the user, etc. Examples of knowledge element metadata of a knowledge element may include one or more of key terms associated with the knowledge element, a publisher of the knowledge element, a title of the knowledge element, a topic of the knowledge element, a category associated with the knowledge element, and a timestamp of the knowledge element, etc.

At block 1704, the generated user vectors are grouped into clusters based on a clustering distance metric between the user vectors. For example, user vectors that are similar to each other or within a certain Euclidean distance of each other can be grouped into a cluster. As another example, user vectors that share more than a predetermined number of the same user profile information can be grouped into a cluster. In some embodiments, a user vector can belong to more than one cluster. In some embodiments, each of the different types of user profile information (e.g., seeded profile information, the interaction data, the knowledge element metadata, or a subtype of any of these types of information) can be maskable or masked out when grouping the user vectors into clusters.

At block 1706, for each cluster, a centroid of the cluster can be determined. The centroid of a cluster can be, for example, a numeric value representing a mean or average of the user vectors that make up the cluster. In some embodiments, the centroid of a cluster can be used as a cluster identifier to uniquely identify a cluster. At block 1708, for each cluster, at least some of the knowledge elements that the users of the user vectors making up the cluster have interacted with can be associated with the cluster. For example, the most popular knowledge elements amongst the users of the user vectors making up the cluster can be associated with the cluster. The knowledge elements associated with a cluster can be represented as leaf nodes of the centroid of the cluster. In some embodiments, each cluster can be represented as a key-value pair with the key being the cluster identifier (e.g., centroid) and the value being a list of knowledge element identifiers of the knowledge elements that are being associated with the cluster.

At block 1710, a target user vector of a target user is compared with the centroids of clusters determined at block 1706 to determined one or more matching cluster for the target user. A cluster can be considered to be a matching cluster, for example, if a Euclidean distance between the centroid and the target user vector is less than a predetermined distance. In some embodiments, a target user vector may have multiple clusters with a distance that is less than the predetermined distance, and a top number of these clusters (e.g., top five, ten, etc, clusters) can be used as the matching clusters

At block 1712, one or more of the knowledge elements associated with the matching clusters are provided as one or more recommendations to the target user. For example, the knowledge automation system may look up the key-value pair using the centroids of the matching clusters to retrieve the list of knowledge element identifiers associated with the centroids to identify the knowledge elements to recommend to the target user. In some embodiments, the knowledge elements can be filtered to identify knowledge elements that are most relevant or useful to the target user. For example, knowledge elements that the target user has consumed, knowledge elements that are stale, and/or knowledge elements with low ratings can be filtered out when providing the one or more recommendations to the target user.

### IV. Knowledge Pack Creation

In some embodiments, a user (e.g., a knowledge publisher) may custom build a knowledge pack from selected knowledge units, and publish the custom knowledge pack for other users (e.g., knowledge consumers) to consume. The knowledge publisher may target the knowledge pack to specific knowledge consumers. However, solely relying on the knowledge publisher to know which knowledge consumer to target can lead to inaccurate results. For example, the knowledge publisher may not be aware of some users who may be interested in the custom knowledge pack, or the knowledge publisher may assume that a knowledge consumer would be interested when the knowledge consumer is not. As such, the knowledge automation system according to some embodiments may provide adaptive feedback to the knowledge publisher during the knowledge pack creation process to automatically identify and suggest knowledge consumers who may be interested in the knowledge pack being built. As the knowledge publisher adds knowledge units to the knowledge pack, target knowledge consumers for the knowledge pack can be added or removed. In some embodiments, the knowledge automation system may also dynamically suggest one or more categories on how the knowledge pack should be categorized.

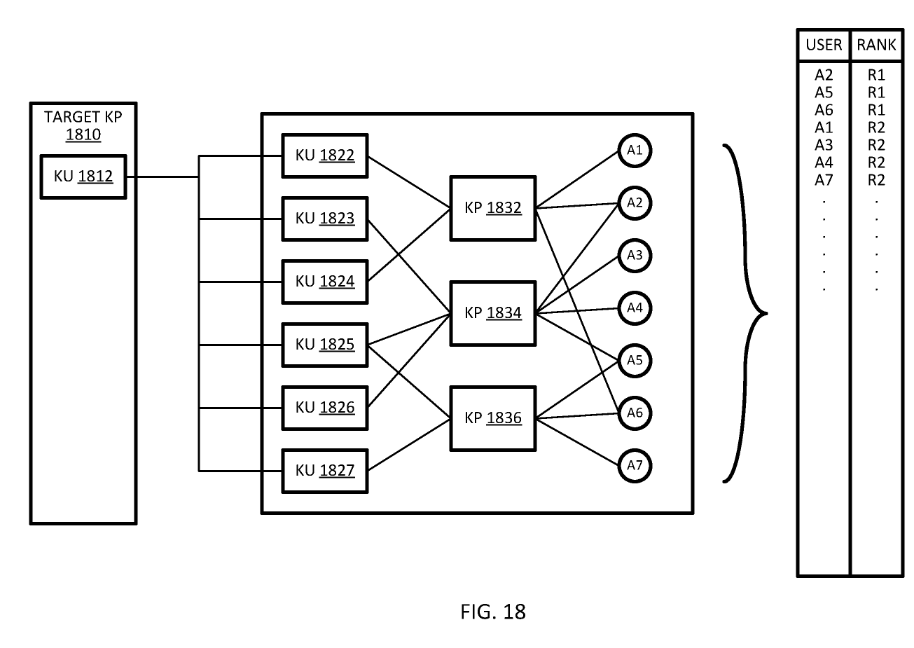

FIG. 18 illustrates a conceptual diagram of adaptive feedback provided by a knowledge automation system during the creation of a knowledge pack, according to some embodiments. Target knowledge pack 1810 is a knowledge pack being built by a knowledge publisher. Initially, target knowledge pack 1810 does not include any content. A knowledge publisher may associate target knowledge pack 1810 with certain metadata such as a title for target knowledge pack 1810, and publisher preferences such as an initial set of one or more target knowledge consumers identified by the knowledge publisher, and/or an initial set of one or more target categories to categorize the target knowledge pack as defined by the knowledge publisher, etc.

To build target knowledge pack 1810, a knowledge publisher may select a knowledge unit 1812 from a set of available knowledge units (e.g., knowledge units stored at a knowledge bank) for addition into target knowledge pack 1810. When the knowledge automation system detects the selection of knowledge unit 1812 for addition into target knowledge pack 1810, the knowledge automation system can compute a knowledge unit distance metric between selected knowledge unit 1812 and each of the remaining available knowledge units. If the knowledge unit distance metric has previously been computed, the previously computed knowledge unit distance metric can be retrieved instead. The knowledge unit distance metric between selected knowledge unit 1812 and a remaining available knowledge unit can be based on a comparison of the content and/or metadata of selected knowledge unit 1812 with the content and/or metadata of the remaining available knowledge units.

In some embodiments, the knowledge unit distance metric can be, for example, a Euclidean distance computed between the term vector of selected knowledge unit 1812 and the term vector of a remaining available knowledge unit. For example, the term vector associated with a knowledge unit can be modeled as a n-dimensional vector. Each key term or group of key terms can be modeled as a dimension. The frequency of occurrence for a key term or group of key terms can be modeled as another dimension. Concept or concepts covered by the knowledge unit can be modeled as a further dimension. Other metadata such as author or source of the knowledge unit can each be modeled as other dimensions, etc. Thus, each knowledge unit can be modeled as vector in n-dimensional space. The knowledge unit distance metric between two knowledge units can then be determined by computing a Euclidean distance in n-dimensional space between the end points of the two vectors representing the two knowledge units. In some embodiments, certain dimensions may be weighted differently than other dimensions. For example, the dimension or dimensions representing key terms in a knowledge unit can be weighted more heavily than the dimensions representing metadata in the Euclidean distance computation. In some embodiments, certain attributes of the knowledge unit (e.g., author, etc.) in a term vector can also be masked such that the underlying attribute is not included in the Euclidean distance computation.

Based on the knowledge unit distance metric, a set of one or more relevant knowledge units from that are deemed similar to the selected knowledge unit 1812 can be determined. For example, a knowledge unit having a knowledge unit distance metric below a predetermined threshold distance away from the selected knowledge unit can be deemed as being similar to the selected knowledge unit, and thus is determined as a relevant knowledge unit. In FIG. 18, knowledge units 1822 to 1827 may have a knowledge unit distance metric between the corresponding knowledge unit and the select knowledge below the threshold distance, and thus knowledge units 1822 to 1827 are identified as relevant knowledge units that are similar to selected knowledge unit 1812.

Having determined which knowledge units are similar to selected knowledge unit 181, the knowledge automation system identifies, for each of the relevant knowledge units 1822-1827, one or more knowledge packs that the relevant knowledge unit is part of. Referring to the example shown in FIG. 18, knowledge unit 1822 is part of knowledge pack 1832; knowledge unit 1823 is part of knowledge pack 1834; knowledge unit 1824 is part of knowledge pack 1832; knowledge unit 1825 is part of knowledge pack 1834; knowledge unit 1825 is part of knowledge packs 1834 and 1836; knowledge unit 1826 is part of knowledge pack 1834; and knowledge unit 1827 is part of knowledge pack 1836. Thus, knowledge packs 1832, 1834, and 1836 are identified by the knowledge automation system.

Next, knowledge consumers who have previously consumed one or more of the identified knowledge packs 1832, 1834, and 1836 are identified. In the example shown in FIG. 6, knowledge pack 1832 has been consumed by knowledge consumers A1, A2, and A6; knowledge pack 1834 has been consumed by knowledge consumers A2 to A5; and knowledge pack 1836 has been consumed by knowledge consumers A5 to A7. Thus, knowledge consumers A1 to A7 are identified by the knowledge automation system.

The identified knowledge consumers A1 to A7 are then ranked based the number of identified knowledge packs 1832, 1834, and 1836 that each identified knowledge consumer has consumed. Referring to FIG. 18, knowledge consumers A2, A5, and A6 are ranked highest, because each of these knowledge consumers have consumed two of the identified knowledge packs. Knowledge consumers A1, A3, A4, and A7 are ranked second, because each of these knowledge consumers have consumed just one of the identified knowledge packs. From the ranked list of knowledge consumers, the knowledge automation system can determine one or more suggested knowledge consumers for target knowledge pack 1810. For example, a number of the highest ranked knowledge consumers (e.g., top five ranked knowledge consumers) can be determined as the suggested knowledge consumers, or knowledge consumers who have consumed more than a threshold number of the identified knowledge packs can be determined as the suggested knowledge consumers. The list of the suggested knowledge consumers can be presented to the knowledge publisher to be considered for addition as the target audience of target knowledge pack 1810.

In the example shown in FIG. 18, the set of identified knowledge packs 1832, 1834, and 1836 is a union of the sets of knowledge packs that each of the knowledge units 1822 to 1827 are part of, and does not include any duplicates. In some embodiments, instead of forming a union that removes duplicate knowledge packs, an identified knowledge pack that contains multiple relevant knowledge units can be counted more than once. For example, identified knowledge pack 1832 contains two relevant knowledge units 1822 and 1824, and thus instead of counting identified knowledge pack 132 as just one identified knowledge pack that its knowledge consumers A1, A2, and A6 have consumed, identified knowledge pack 132 can be counted as two identified knowledge packs that its knowledge consumers A1, A2, and A6 have consumed.

As the knowledge publisher builds target knowledge pack 1810, the list of suggested knowledge consumers provided by the knowledge automation system may change. When a second knowledge unit is selected for addition into target knowledge pack 1810, a similar analysis can be performed for the second knowledge unit to identify relevant knowledge units, their associated knowledge packs, and knowledge consumers who have previously consumed the identified knowledge packs. The knowledge consumers identified for that second knowledge unit being added to target knowledge pack 1810 can be ranked together with the ones identified for knowledge unit 1812 to determine the set of suggested knowledge consumers to recommend to the knowledge publisher, and this process can be performed each time a new knowledge unit is added to target knowledge pack 1810.

The analysis of identify the knowledge consumers for a knowledge pack being added to the target knowledge pack can be performed separately for each knowledge unit being added. Thus, in some embodiments, the analysis performed for a knowledge unit can be cached such that the analysis performed for that knowledge unit need not be repeated each time an additional knowledge unit is added to target knowledge pack 1810. In some embodiments, instead of separating out identification of the knowledge consumers for each knowledge unit being added to target knowledge pack 1810, a union of the relevant knowledge units or a union of the identified knowledge packs for each knowledge unit being added to the target knowledge pack 1810 can be formed. This would remove duplicate relevant knowledge units or duplicate identified knowledge packs across all knowledge units being added to the target knowledge pack 1810, and identification of the knowledge consumers can be determined from the resulting union with the duplicates removed.

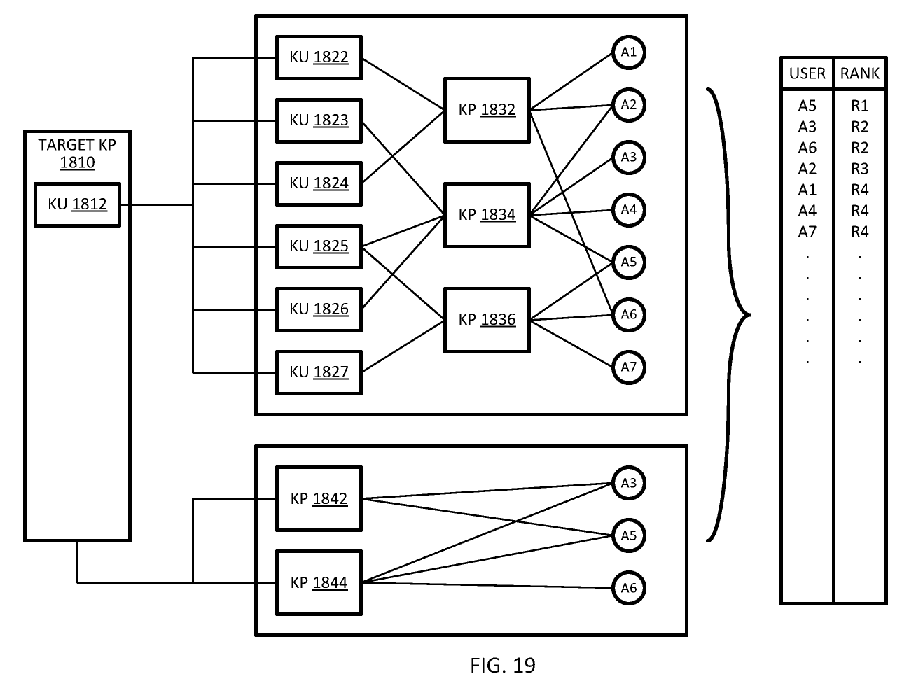

FIG. 19 illustrates another conceptual diagram of adaptive feedback provided by a knowledge automation system during the creation of a knowledge pack, according to some embodiments. In the example shown in FIG. 18, the adaptive feedback of suggested knowledge consumers for a target knowledge pack is determined by identifying relevant knowledge units that are similar to a knowledge unit being added to the target knowledge pack. In some embodiments, in addition to using relevant knowledge units, the suggested knowledge consumers can also be determined based on knowledge packs that are similar to the target knowledge pack being built. FIG. 19 illustrates an example of this.

In addition to the analysis performed for the selected knowledge unit 1812 being added to target knowledge pack 1810 as described above, the knowledge automation system may also compute, for each published knowledge pack in the system, a knowledge pack distance metric between the target knowledge pack 1810 and the published knowledge pack by comparing metadata (e.g., title, publisher, etc.) of the target knowledge pack 1810 with metadata (e.g., title, publisher, etc.) of the published knowledge pack. Based on the knowledge pack distance metric, a set of one or more relevant knowledge packs can be determined. For example, a published knowledge pack can be determined as a relevant knowledge pack if the knowledge pack distance metric computed between the target knowledge pack and that published knowledge pack is below a threshold distance. Referring to the example shown in FIG. 19, published knowledge pack 1842 and 1844 are determined to be relevant knowledge packs to target knowledge pack 1810.

From the relevant knowledge packs 1842 and 1844, a second set of knowledge consumers is identified, each of which being a knowledge consumer of at least one of the relevant knowledge packs 1842 and 1844. In the example shown in FIG. 19, the identified knowledge consumers of relevant knowledge pack 1842 are knowledge consumer A3 and A5, and the identified knowledge consumers of relevant knowledge pack 1844 are knowledge consumer A3, A5, and A6. This second set of identified knowledge consumers can then be ranked together with the identified knowledge consumers from the relevant knowledge unit analysis to determine the suggested knowledge consumes for target knowledge pack 1810.

In the example shown in FIG. 19, knowledge consumer A5 is ranked first, because knowledge consumer A5 has consumed the highest number of the identified and relevant knowledge packs (e.g., knowledge packs 1834, 1836, 1842, and 1844). Knowledge consumers A3 and A6 are ranked second, because they have consumed the second highest number of the identified and relevant knowledge packs (e.g., knowledge packs 1834, 1842, and 1844 for knowledge consumer A3, and knowledge packs 1832, 1836, and 1844 for knowledge consumer A6), and so on.

In some embodiments, when ranking the knowledge consumers from the two different sets of knowledge consumers together, different weighing factors can be applied to the two sets of knowledge consumers. For example, because the similarity between knowledge packs may matter less than the similarity between knowledge units, the number of relevant knowledge packs counted for a knowledge consumer in the second set can be discounted by a factor. By way of example, referring to FIG. 19, instead of counting two as the number of relevant knowledge packs that knowledge consumer A3 have consumed (e.g., knowledge packs 1842 and 1844), this number can be reduced by multiply with a weighing factor such as 0.5, so that the two knowledge packs for consumer A3 are counted as just one during the ranking.

In some embodiments, the adaptive feedback provided by a knowledge automation system may also include suggestions of categories to categorize the target knowledge pack being built. The analysis to derive the suggested categories is similar to the analysis to derive the suggested knowledge consumers described above, and hence a detailed description of which need not be repeated. Referring to FIG. 18, to derive suggested categories, reference designations A1 to A7 would each represent a category of which at least one of the identified knowledge packs 1832, 1834, and 1836 belongs to. Thus, instead of or in addition to identify knowledge consumers, the knowledge automation system may identify a set of one or more categories, each of which being a category that at least one of the identified knowledge packs 1832, 1834, and 1836 belongs to. The categories A1 to A7 can be ranked to determine one or more suggested categories for target knowledge pack 1810.

Similarly, referring to FIG. 19, a first set of categories A1 to A7, each of which being a category of at least one of the identified knowledge packs 1832, 1834, and 1836 can be determined based on a knowledge unit distance metric, and a second set of categories A3, A5, and A7, each of which being a category of at least one of the relevant knowledge packs 1842 and 1844 can be determined based on a knowledge pack distance metric. The first set of categories A1 to A7 and the second set of categories A3, A5, and A7 can be ranked together to determine one or more suggested categories for target knowledge pack 1810. As additional knowledge units are added to target knowledge pack 1810, the list of suggested categories can be revised accordingly in a similar manner as that described above for the suggested knowledge consumers.

In some embodiments, the knowledge publisher may have designated the target knowledge pack being built as being intended for a target knowledge consumer. When a selected knowledge unit is added to the target knowledge pack, the adaptive feedback provided by the knowledge automation system may also include suggesting to the knowledge publisher that the current target knowledge consumer should be removed from the intended audience of the target knowledge pack. This may occur, for example, if the knowledge publisher is adding a knowledge unit that the designated target knowledge consumer is not interested in. In some embodiments, the knowledge automation system may determine whether the target knowledge pack is relevant for the target knowledge consumer by comparing the user signature of the target knowledge consumer with the knowledge signature of the knowledge unit being added and/or the knowledge signatures of the knowledge units currently included or being added to the target knowledge pack. If the match score from the comparison is below a threshold score, then the knowledge automation system may suggest to the knowledge publisher that the target knowledge consumer should be removed. In scenarios in which the user signature is compared with each of the knowledge signatures of the knowledge units currently included or being added to the target knowledge pack, the match scores from each comparison can be averaged and then compared with the threshold score.

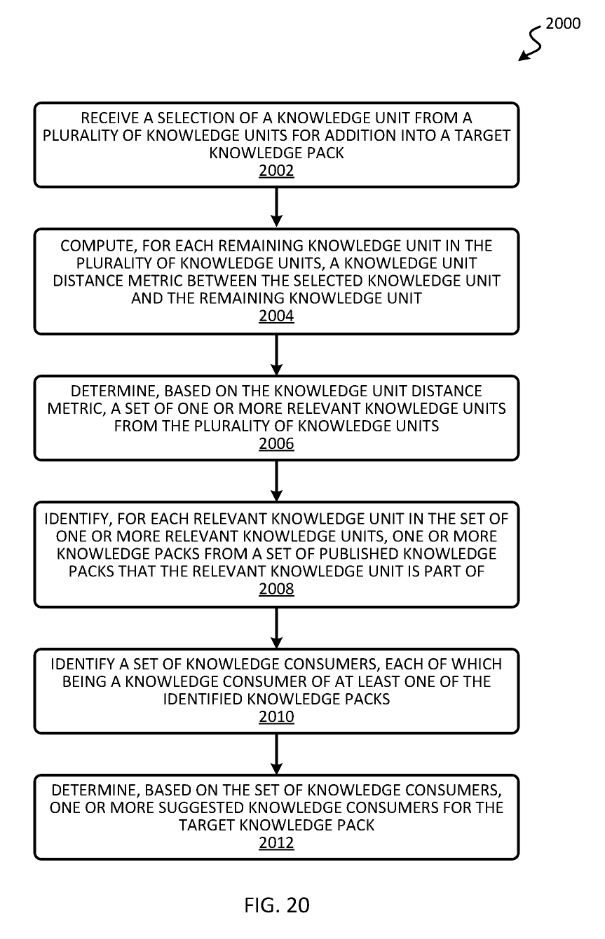

FIG. 20 illustrates a flow diagram of an adaptive feedback process 2000 that can be performed by a knowledge automation system during knowledge pack creation by a knowledge publisher, according to some embodiments. Process 2000 may begin at block 2002 by receiving a selection of a knowledge unit from a plurality of knowledge units (e.g., knowledge units stored in a knowledge bank) for addition into a target knowledge pack.

At block 2004, process 2000 may compute, for each remaining knowledge unit in the plurality of knowledge units, a knowledge unit distance metric between the selected knowledge unit and the remaining knowledge unit. In some embodiments, the knowledge unit distance metric can be computed based on a comparison of the content of the selected knowledge unit with the content of each remaining knowledge unit. In some embodiments, the knowledge unit distance metric can be computed based on a comparison of the content and metadata of the selected knowledge unit with the content and metadata of each remaining knowledge unit. For example, the knowledge unit distance metric can be computed by comparing a term vector of the selected knowledge unit with a term vector of the remaining knowledge unit. The term vector of each knowledge unit may include key terms and/or metadata, and the knowledge unit distance metric can be, for example, a Euclidean distance between the vectors representing the knowledge units in n-dimensional space.

At block 2006, based on the knowledge unit distance metric, a set of one or more relevant knowledge units from the plurality of knowledge units can be determined. For example, a remaining knowledge unit can be determined as a relevant knowledge unit if the knowledge unit distance metric computed between the selected knowledge unit and that remaining knowledge unit is below a predetermined threshold distance. In some embodiments, the one or more relevant knowledge units can be determined by ranking the remaining knowledge units based on the knowledge unit distance metric, and selecting a predetermined number of highest ranked remaining knowledge units as the set of one or more relevant knowledge units. For example, a remaining knowledge unit with a lower knowledge unit distance can be ranked higher than a remaining knowledge unit with a higher knowledge unit distance.

At block 2008, process 2000 may identify, for each relevant knowledge unit in the set of one or more relevant knowledge units, one or more knowledge packs from a set of published knowledge packs that the relevant knowledge unit is part of. At block 2010, a set of knowledge consumers, each of which being a knowledge consumer of at least one of the identified knowledge packs; can be identified.

At block 2012, one or more suggested knowledge consumers for the target knowledge pack can be determined based on the set of knowledge consumers. For example, a knowledge consumer in the identified set of knowledge consumers can be determined as a suggested knowledge consumer of the target knowledge pack if a number of the identified knowledge packs that the knowledge consumer consumes is greater than a predetermined threshold. In some embodiments, one or more suggested knowledge consumers can be determined by ranking the knowledge consumers in the identified set of knowledge consumers based on a number of the identified knowledge packs that each knowledge consumer has consumed, and selecting a predetermined number of highest ranked knowledge consumers as the one or more suggested knowledge consumers. A list of the suggested knowledge consumers can be presented to the knowledge publisher for consideration in adding them to the target audience of the target knowledge pack. In some embodiments, the list of suggested knowledge consumers can be sorted to show the highest ranked suggested knowledge consumer first.

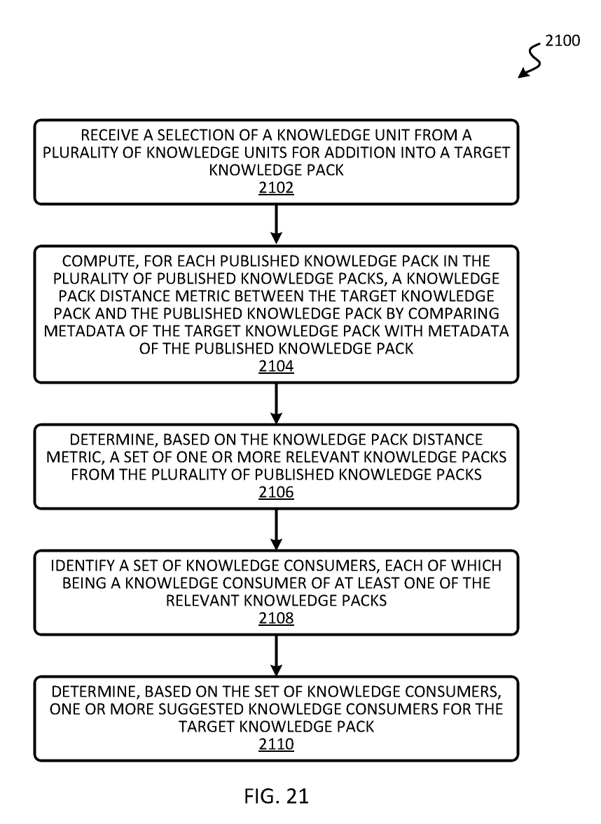

FIG. 21 illustrates a flow diagram of another adaptive feedback process 2100 that can be performed by a knowledge automation system during knowledge pack creation by a knowledge publisher, according to some embodiments. Process 2100 may begin at block 2102 by receiving a selection of a knowledge unit from a plurality of knowledge units (e.g., knowledge units stored in a knowledge bank) for addition into a target knowledge pack.

At block 2104, process 2100 may compute, for each published knowledge pack in the plurality of published knowledge packs, a knowledge pack distance metric between the target knowledge pack and the published knowledge pack by comparing metadata of the target knowledge pack with metadata of the published knowledge pack. At block 2106, a set of one or more relevant knowledge packs from the plurality of published knowledge packs can be determined based on the knowledge pack distance metric. For example, a published knowledge pack can be determined as a relevant knowledge pack if the knowledge pack distance metric computed between the target knowledge pack and that published knowledge pack is below a threshold distance. In some embodiments, the set of one or more relevant knowledge packs can be determined by ranking the published knowledge packs based on the knowledge pack distance metric, and selecting a predetermined number of highest ranked published knowledge packs as the set of one or more relevant knowledge packs.

At block 2108, process 2100 can identify a set of knowledge consumers, each of which being a knowledge consumer of at least one of the relevant knowledge packs. At block 2110, one or more suggested knowledge consumers for the target knowledge pack can be determined based on the set of knowledge consumers. In some embodiments, process 2100 can be performed as part of process 1800, and a knowledge consumers can be determined as a suggested knowledge consumer of the target knowledge pack if a sum of a number of the identified knowledge packs from process 1800 and a number of relevant knowledge packs that the knowledge consumer consumes from process 2100 is greater than a predetermined threshold.

In some embodiments, additionally or alternatively to determining suggested knowledge consumers for a target knowledge pack, processes 1800 and 2100 can also be used to determine suggested categories for a target knowledge pack. For example, such processes may include identifying a set of one or more categories, each of which being a category of at least one of the identified knowledge packs in process 1800, and determining, based on the set of one or more categories, one or more suggested categories for the target knowledge pack. As another example, such processes may include identifying a first set of one or more categories, each of which being a category of at least one of the identified knowledge packs from process 1800, identifying a second set of one or more categories, each of which being a category of at least one of the relevant knowledge packs from process 2100; and determining, based on the first and second sets of one or more categories, one or more suggested categories for the target knowledge pack. A list of the suggested categories can be presented to the knowledge publisher for consideration in adding them to the target categories of the target knowledge pack. In some embodiments, the list of suggested categories can be sorted to show the highest ranked suggested category first.

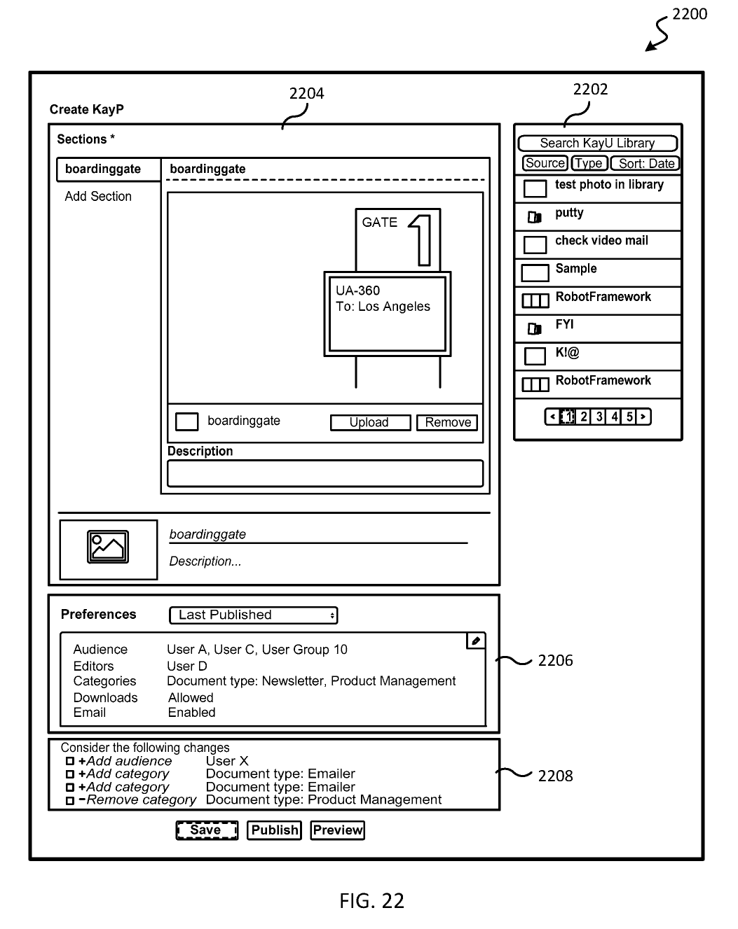

FIG. 22 illustrates a graphical user interface 2200 for building a knowledge pack, according to some embodiments. Graphical user interface 2200 may include a knowledge unit library area 2202, a target knowledge pack building area 2204, a preferences area 2206, and a recommendations area 2208. Knowledge unit library area 2202 may display knowledge unit icons representing knowledge units that are available for a knowledge publisher to add to a custom target knowledge pack being built. The knowledge unit library area 2202 may include a search bar to allow a knowledge publisher to search for knowledge units. The knowledge unit icons can be displayed in a list and may be sortable by content source, type, and/or date of the correspond knowledge units.

Target knowledge pack building area 2204 is a working area where a knowledge publisher can build a target knowledge pack. A knowledge publisher may select a knowledge unit icon from knowledge unit library area 2202, and place the icon in target knowledge pack building area 2204 to add the corresponding knowledge unit to the knowledge pack being built. In some embodiments, this can be done in a drag and drop manner. In the example shown in FIG. 22, a knowledge publisher has dragged an icon representing a knowledge unit relating to “boarding gate” (e.g., an image of a boarding gate) onto the target knowledge pack building area 2204. In some embodiments, a preview of the knowledge unit being added to the target knowledge pack can be displayed in target knowledge pack building area 2204 as shown.

Preference area 2206 may display preferences for the target knowledge pack being built as set by the knowledge publisher. For example, preference area 2206 may display a target audience that the knowledge publisher has set for the target knowledge pack, editors who can edit the target knowledge pack, target categories that the knowledge publisher has set for the target knowledge pack, and access control information such as whether the knowledge publisher permits the target knowledge pack to be downloaded or emailed.

Recommendations area 2208 may display adaptive feedback information that the knowledge automation system may provide as the target knowledge pack is being built. For example, recommendations area 2208 may display a list of one or more suggested knowledge consumers for addition to the target audience, and/or a list of one or more suggested categories for addition to the target categories. In some embodiments, recommendations area 2208 may also display a list of one or more target knowledge consumers for removal from the target audience, and/or a list of one or more target categories for removal from the target categories. As the knowledge publisher adds knowledge units to the target knowledge pack, the information displayed in recommendations area 2208 will change accordingly, for example, based on processes 1800 and 1900 described above. In some embodiments, one or more check boxes can be displayed in recommendations area 2208 to allow the knowledge publisher to selectively adopt one or more of the recommendations suggested by the knowledge automation system. If the knowledge publisher adopts any of the recommendations, preference area 2206 may display the updated information, for example, by updating the target audience and/or target category.

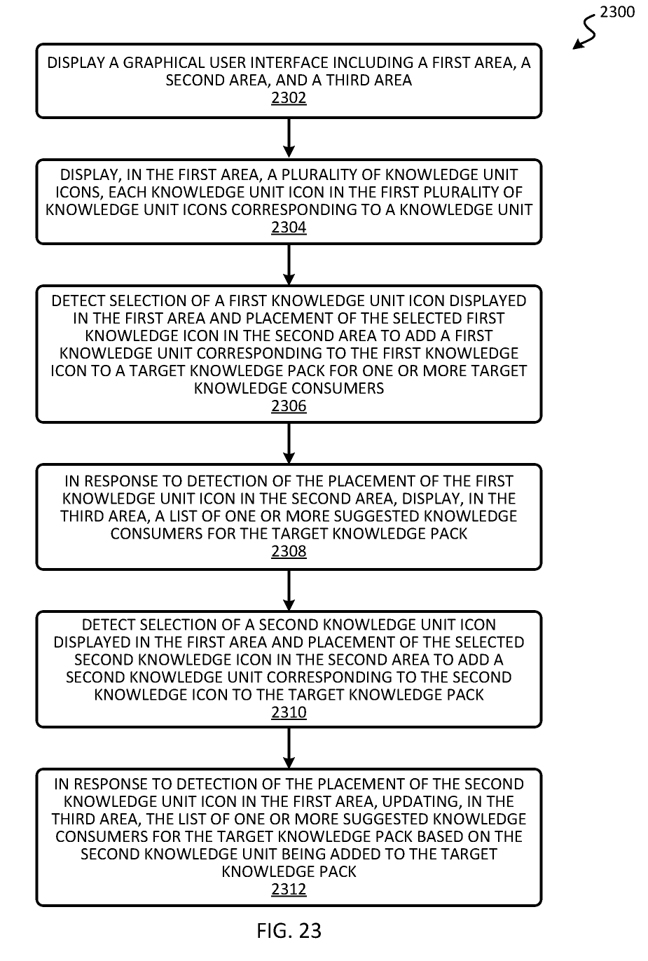

FIG. 23 illustrates a flow diagram of a process 2300 for displaying a knowledge pack builder graphical user interface, according to some embodiments. Process 2300 may begin at block 2302 by displaying a graphical user interface including at least a first area, a second area, and a third area. In some embodiments, process 2300 may also display one or more target knowledge consumers of the target knowledge pack, and one or more target categories of the target knowledge pack in a fourth area. At block 2304, process 2300 may display, in the first area, a plurality of knowledge unit icons, each knowledge unit icon in the first plurality of knowledge unit icons corresponding to a knowledge unit. At block 2306, process 2300 may detect selection of a first knowledge unit icon displayed in the first area and placement of the selected first knowledge icon in the second area to add a first knowledge unit corresponding to the first knowledge icon to a target knowledge pack for one or more target knowledge consumers.

At block 2308, in response to detecting the placement of the first knowledge unit icon in the second area, process 2300 may display, in the third area, a list of one or more suggested knowledge consumers for the target knowledge pack. At block 2310, process 2300 may detect selection of a second knowledge unit icon displayed in the first area and placement of the selected second knowledge icon in the second area to add a second knowledge unit corresponding to the second knowledge icon to the target knowledge pack. At block 2312, in response to detecting the placement of the second knowledge unit icon in the first area, process 2300 may update, in the third area, the list of one or more suggested knowledge consumers for the target knowledge pack based on the second knowledge unit being added to the target knowledge pack.

Additional processing that can be performed by process 2300 to provide adaptive feedback to the knowledge publisher may include displaying, in the third area, a list of one or more suggested categories for the target knowledge pack, in response to detecting the placement of the first knowledge unit icon in the second area, and updating, in the third area, the list of one or more suggested categories for the target knowledge pack based on the second knowledge unit being added to the target knowledge pack in response to detecting the placement of the second knowledge unit icon in the first area. Process 2300 may also, in response to detecting the placement of the first or second knowledge unit icon in the second area, display, in the third area, an indicator recommending removal of one or more of the target knowledge consumers of the target knowledge pack and/or an indicator recommending removal of one or more target categories of the target knowledge pack.

### V. Identification and Bridging of Knowledge Gap

In a knowledge automation system, knowledge gaps can exist where the knowledge available in the system may lack certain content to fill the needs of all users. For example, knowledge gaps can result from missing information, inaccessible information, or information that has not been organized in an easily consumable manner. Knowledge gaps may also vary from one user to another user (e.g., one user's familiarity with a subject area may mean that no knowledge gap is observed whereas a less experienced user may be left searching for knowledge). Automatically identifying knowledge gaps in a knowledge automation system can improve the knowledge coverage of the knowledge automation system. For example, topic areas where a potential knowledge gap may exist can be provided to a knowledge publisher to prompt the knowledge publisher to add new content to the system to bridge the gap.

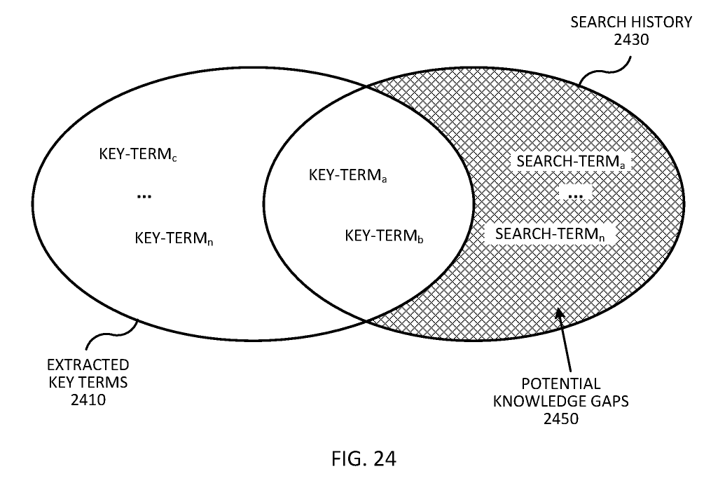

FIG. 24 illustrates a conceptual diagram of potential knowledge gaps in a knowledge automation system, according to some embodiments. In FIG. 24, ellipse 2410 can represent the set of key terms extracted from the knowledge corpus of a knowledge automation system. In some embodiments, the key terms may map to the known taxonomy of the knowledge automation system. Ellipse 2430 can represent the search history of search terms performed by users in the system. As shown in FIG. 24, not all terms searched by users of the knowledge automation system may match a key term extracted from the knowledge corpus. A search term that does not match a key term in the knowledge corpus can be identified as a potential knowledge gap. Thus, the patterned region 2450 in FIG. 24 may represent the potential knowledge gaps in the knowledge automation system.

In some embodiments, user activities and interactions with the knowledge automation system can be monitored and analyzed to identify one or more knowledge gaps. As illustrated above, search analyses on search terms can be performed, and may include analyzing the contents of search results, and analyzing how users are rating and/or interacting with the search results. For example, if a search query returns zero results, then the category and/or search term used can be added to a list of potential knowledge gaps. If a search query does yield results, but the results are either explicitly (e.g., by user rating) or inferentially (e.g., based on lack of viewership, repeated searches using variations of a search term within a short time period, etc.) deemed to be poor, then the category and/or search term used in the search query can be added to a list of potential knowledge gaps. Similarly, if the user does not retrieve any content listed in the search results, or if the user had to traverse down several pages of the search results, then the category and/or search term used in search query can be added to a list of potential knowledge gaps.

In some embodiments, comments made by users on the knowledge elements in the system can also be analyzed. The comments can be analyzed using a sentiment analysis to determine whether users are leaving questions about the knowledge elements viewed by the users. Categories and/or topics for these knowledge elements can be identified and added to a list of potential knowledge gaps. The viewership rates and/or completion rates of particular knowledge elements can also be analyzed. In some embodiments, this can also be used to identify knowledge quality issues with particular knowledge elements. For example, if a particular knowledge pack on a particular topic has a high viewership but still results in one or more knowledge gaps related to that topic, then a potential knowledge quality issue can be identified for that particular knowledge pack.

The knowledge gaps can be identified on a per user basis, per use group basis, or system wide. A given list of potential knowledge gaps can be sorted based on the source of the knowledge gap, the reliability of the methods used to identify the potential knowledge gap, and whether similar knowledge gaps have been identified for other users. The potential knowledge gaps can then be submitted to knowledge publishers to the address the knowledge gaps (e.g., publish new knowledge into the system, retarget existing knowledge to other users of the system who have those knowledge gaps, improve the quality of their published knowledge if it corresponds to the knowledge gaps, etc.).

In some embodiments, a graphical user interface can be provided to provide a visualization of knowledge gaps. For example, a bubble chart similar FIG. 12 can be used, where each bubble may represent a knowledge gap for a category or key term that may be lacking useful content in the system, and the size of the bubble may represent the size of the knowledge gap (e.g., the size of a knowledge gap may correlate to how frequently users are searching for the category or key term). In some embodiments, publishing history can be analyzed over a period of time to determine areas in which a knowledge publisher is likely to publish in. The system can correlate those areas to existing or anticipated knowledge gaps, and notify the knowledge publisher of the knowledge gaps, prompting the knowledge publisher to add or modify content to bridge the gaps. In some embodiments, a knowledge service can automatically search various data sources (e.g., including the Internet) based on the identified knowledge gaps, and the results can be provided to the knowledge publisher to accelerate bridging of the gap.

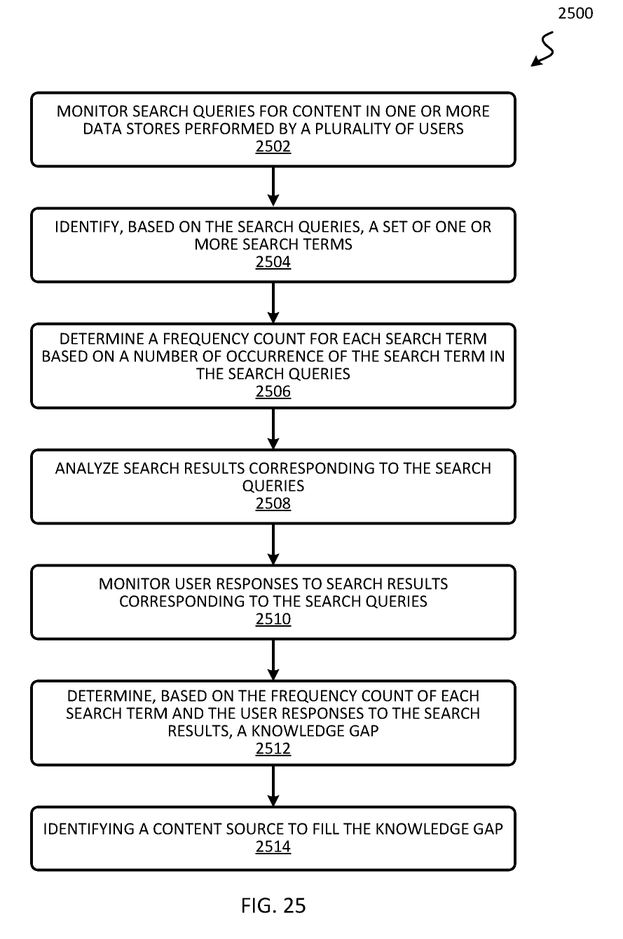

FIG. 25 illustrates a flow diagram of a process 2500 for automatically identifying a knowledge gap that can be performed by a knowledge automation system, according to some embodiments. Process 2500 may begin at block 2502 by monitoring search queries for content or knowledge in one or more data stores performed by users of the system. At block 2504, process 2500 may identify, based on the search queries, a set of one or more search terms. The search terms can be, for example, words or phrases used in the search queries.

At block 2506, a frequency count for each identified search term can be determined based on the number of occurrence of the search term in the search queries. In other words, the number of times a search term is searched, and/or when the search term is searched can be tracked. In some embodiments, a high frequency count of a search term coupled with poor search results for that search term may indicate a potential knowledge gap, because a large number of users may be seeking knowledge relating to the search term. A low frequency count of a search term, even if it yields poor results, may not necessary mean that a potential knowledge gap exists. For example, the poor results can be due to a typographical error in the search term.

At block 2508, search results corresponding to the search queries can be analyzed. For example, the number of knowledge elements included in each search result can be determined. A search result for a search query may return a list of one or more knowledge elements (e.g., knowledge units and/or knowledge packs), or a search result may return zero results. In some embodiments, the number of knowledge elements in a search result can be used to indicate whether there is a potential knowledge gap. A lower number of knowledge elements returned in a search result may indicate a higher likelihood of a potential knowledge gap. However, a higher number of knowledge elements may not necessary mean that a potential knowledge gap exists, because the search result can be ineffective and may return irrelevant knowledge elements. In some embodiments, the staleness of the knowledge elements returned in a search result may also indicate a potential knowledge gap where the available information pertaining to a particular search term may be outdated, and more updated information is desired.

As such, at block 2510, user responses to the search results corresponding to the search queries can also be monitored. User responses such as how the user is interacting with the a search result can provide an indication as to the effectiveness of the search result. For example, the number of knowledge elements from a search result that a user retrieves and/or the depth into the list of knowledge elements that a user traverses may provide an indication of the quality of the search result. In some embodiments, a greater the number of knowledge elements that a user retrieves may indicate a higher likelihood that the search result is ineffective and is returning irrelevant knowledge elements. Similarly, the deeper down the list of knowledge elements of a search result that a user traverses, the higher the likelihood that the search result is ineffective. In some embodiments, the amount of time spent by a user viewing each search result, the amount of time spent by a user viewing each retrieved knowledge element in the search result, and the amount of time before a user performs a subsequent search can also be taken into account.

At block 2512, process 2500 may determine, based on the frequency count of each search term, the search results, and the user responses to the search results, a knowledge gap indicating a potential lack of content associated with a particular search term. For example, in some embodiments, a search term may correlate to a knowledge gap if a frequency count of the particular search term is above a predetermined threshold count, and the search results are deemed ineffective based on the user responses to the search results. In some embodiments, a knowledge gap score can be computed for each search term, or each search term that has a frequency count above a predetermined threshold count. The knowledge gap score can be a weighted sum of values representing each factor that is being taken into account (e.g., frequency count of the search term, number of knowledge elements returned, amount of time user spends, etc.), and a search term can be identified as a knowledge gap if the knowledge gap score is above a threshold value.

At block 2514, process 2500 may identify one or more content sources to fill the knowledge gap. For example, process 2500 may identify a content publisher who has provided or published content similar to the search term associated with the knowledge gap, or content publisher who has provided or published content previously consumed by users performing the search queries with the search term. The knowledge automation system may then send a request to the content publisher to add data content to fill the knowledge gap. In some embodiments, the knowledge automation system may also initiate content discovery to search for content in one or more content sources such as the Internet.

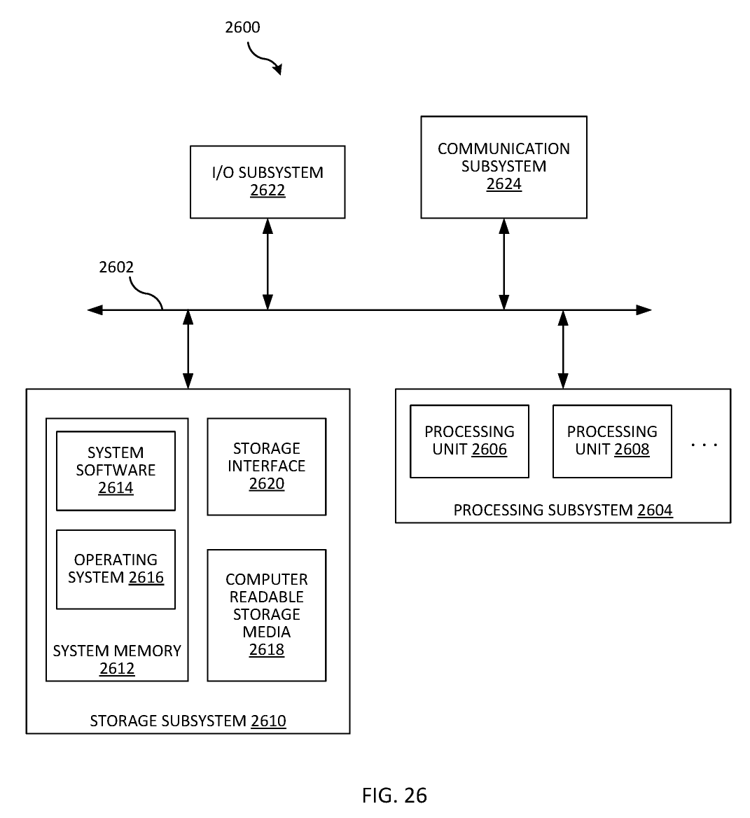

FIG. 26 depicts a block diagram of a computing system 2600, in accordance with some embodiments. Computing system 2600 can include a communications bus 2602 that connections one or more subsystems, including a processing subsystem 2604, storage subsystem 2610, I/O subsystem 2622, and communication subsystem 2624.

In some embodiments, processing subsystem 2608 can include one or more processing units 2606, 2608. Processing units 2606, 2608 can include one or more of a general purpose or specialized microprocessor, FPGA, DSP, or other processor. In some embodiments, processing unit 2606, 2608 can be a single core or multicore processor.

In some embodiments, storage subsystem can include system memory 2612 which can include various forms of non-transitory computer readable storage media, including volatile (e.g., RAM, DRAM, cache memory, etc.) and non-volatile (flash memory, ROM, EEPROM, etc.) memory. Memory may be physical or virtual. System memory 2612 can include system software 2614 (e.g., BIOS, firmware, various software applications, etc.) and operating system data 2616. In some embodiments, storage subsystem 2610 can include non-transitory computer readable storage media 2618 (e.g., hard disk drives, floppy disks, optical media, magnetic media, and other media). A storage interface 2620 can allow other subsystems within computing system 2600 and other computing systems to store and/or access data from storage subsystem 2610.

In some embodiments, I/O subsystem 2622 can interface with various input/output devices, including displays (such as monitors, televisions, and other devices operable to display data), keyboards, mice, voice recognition devices, biometric devices, printers, plotters, and other input/output devices. I/O subsystem can include a variety of interfaces for communicating with I/O devices, including wireless connections (e.g., Wi-Fi, Bluetooth, Zigbee, and other wireless communication technologies) and physical connections (e.g., USB, SCSI, VGA, SVGA, HDMI, DVI, serial, parallel, and other physical ports).

In some embodiments, communication subsystem 2624 can include various communication interfaces including wireless connections (e.g., Wi-Fi, Bluetooth, Zigbee, and other wireless communication technologies) and physical connections (e.g., USB, SCSI, VGA, SVGA, HDMI, DVI, serial, parallel, and other physical ports). The communication interfaces can enable computing system 2600 to communicate with other computing systems and devices over local area networks wide area networks, ad hoc networks, mesh networks, mobile data networks, the internet, and other communication networks.

In certain embodiments, the various processing performed by a knowledge modeling system as described above may be provided as a service under the Software as a Service (SaaS) model. According this model, the one or more services may be provided by a service provider system in response to service requests received by the service provider system from one or more user or client devices (service requestor devices). A service provider system can provide services to multiple service requestors who may be communicatively coupled with the service provider system via a communication network, such as the Internet.

In a SaaS model, the IT infrastructure needed for providing the services, including the hardware and software involved for providing the services and the associated updates/upgrades, is all provided and managed by the service provider system. As a result, a service requester does not have to worry about procuring or managing IT resources needed for provisioning of the services. This significantly increases the service requestor's access to these services in an expedient manner at a much lower cost point.

In a SaaS model, services are generally provided based upon a subscription model. In a subscription model, a user can subscribe to one or more services provided by the service provider system. The subscriber can then request and receive services provided by the service provider system under the subscription. Payments by the subscriber to providers of the service provider system are generally done based upon the amount or level of services used by the subscriber.

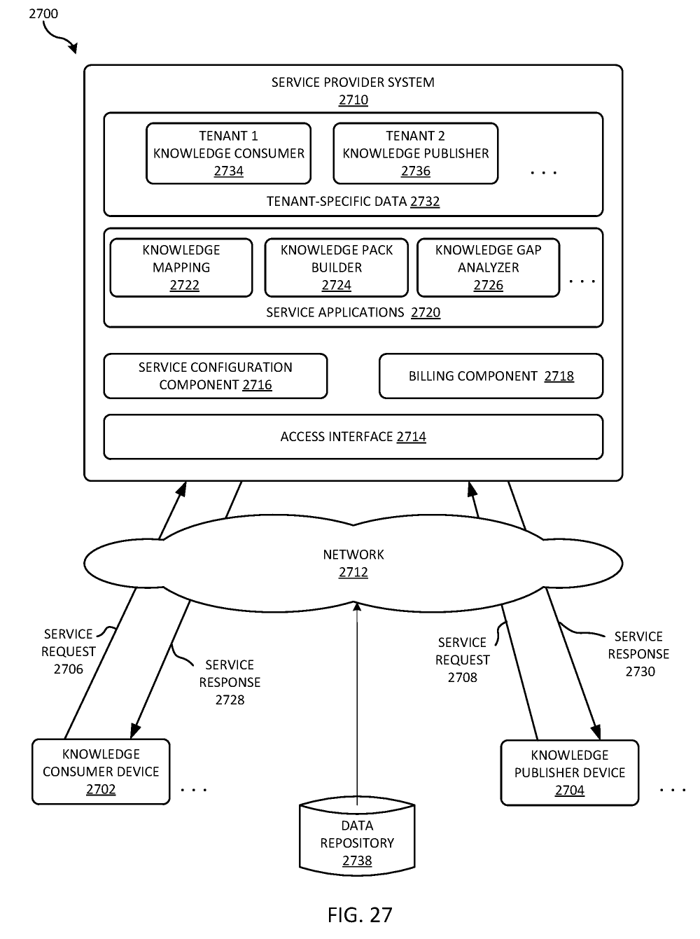

FIG. 27 depicts a simplified block diagram of a service provider system 2700, in accordance with some embodiments. In the embodiment depicted in FIG. 27, service requestor devices 2704 and 2704 (e.g., knowledge consumer device and/or knowledge publisher device) are communicatively coupled with service provider system 2710 via communication network 2712. In some embodiments, a service requestor device can send a service request to service provider system 2710 and, in response, receive a service provided by service provider system 2710. For example, service requestor device 2702 may send a request 2706 to service provider system 2710 requesting a service from potentially multiple services provided by service provider system 2710. In response, service provider system 2710 may send a response 2728 to service requestor device 2702 providing the requested service. Likewise, service requestor device 2704 may communicate a service request 2708 to service provider system 2710 and receive a response 2730 from service provider system 2710 providing the user of service requestor device 2704 access to the service. In some embodiments, SaaS services can be accessed by service requestor devices 2702, 2704 through a thin client or browser application executing on the service requestor devices. Service requests and responses 2728, 2730 can include HTTP/HTTPS responses that cause the thin client or browser application to render a user interface corresponding to the requested SaaS application. While two service requestor devices are shown in FIG. 27, this is not intended to be restrictive. In other embodiments, more or less than two service requestor devices can request services from service provider system 2710.

Network 2712 can include one or more networks or any mechanism that enables communications between service provider system 2710 and service requestor devices 2702, 2704. Examples of network 2712 include without restriction a local area network, a wide area network, a mobile data network, the Internet, or other network or combinations thereof. Wired or wireless communication links may be used to facilitate communications between the service requestor devices and service provider system 2710.

In the embodiment depicted in FIG. 27, service provider system 2710 includes an access interface 2714, a service configuration component 2716, a billing component 2718, various service applications 2720, and tenant-specific data 2732. In some embodiments, access interface component 2714 enables service requestor devices to request one or more services from service provider system 2710. For example, access interface component 2714 may comprise a set of webpages that a user of a service requestor device can access and use to request one or more services provided by service provider system 2710.

In some embodiments, service manager component 2716 is configured to manage provision of services to one or more service requesters. Service manager component 2716 may be configured to receive service requests received by service provider system 2710 via access interface 2714, manage resources for providing the services, and deliver the services to the requesting requesters. Service manager component 2716 may also be configured to receive requests to establish new service subscriptions with service requestors, terminate service subscriptions with service requestors, and/or update existing service subscriptions. For example, a service requestor device can request to change a subscription to one or more service applications 2722-2726, change the application or applications to which a user is subscribed, etc.).

Service provider system 2710 may use a subscription model for providing services to service requestors according to which a subscriber pays providers of the service provider system based upon the amount or level of services used by the subscriber. In some embodiments, billing component 2718 is responsible for managing the financial aspects related to the subscriptions. For example, billing component 2710, in association with other components of service provider system 2710, may be configured to determine amounts owed by subscribers, send billing statements to subscribers, process payments from subscribers, and the like.

In some embodiments, service applications 2720 can include various applications that provide various SaaS services. For example, one more applications 2720 can provide the various functionalities described above and provided by a knowledge modeling system.

In some embodiments, tenant-specific data 2732 comprises data for various subscribers or customers (tenants) of service provider system 2710. Data for one tenant is typically isolated from data for another tenant. For example, tenant 1's data 2734 is isolated from tenant 2's data 2736. The data for a tenant may include without restriction subscription data for the tenant, data used as input for various services subscribed to by the tenant, data generated by service provider system 2710 for the tenant, customizations made for or by the tenant, configuration information for the tenant, and the like. Customizations made by one tenant can be isolated from the customizations made by another tenant. The tenant data may be stored service provider system 2710 (e.g., 2734, 2736) or may be in one or more data repositories 2738 accessible to service provider system 2710.

It should be understood that the methods and processes described herein are exemplary in nature, and that the methods and processes in accordance with some embodiments may perform one or more of the steps in a different order than those described herein, include one or more additional steps not specially described, omit one or more steps, combine one or more steps into a single step, split up one or more steps into multiple steps, and/or any combination thereof.

It should also be understood that the components (e.g., functional blocks, modules, units, or other elements, etc.) of the devices, apparatuses, and systems described herein are exemplary in nature, and that the components in accordance with some embodiments may include one or more additional elements not specially described, omit one or more elements, combine one or more elements into a single element, split up one or more elements into multiple elements, and/or any combination thereof.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps. Various features and aspects of the above-described embodiments may be used individually or jointly.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter-process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific invention embodiments have been described, these are not intended to be limiting. Various modifications and equivalents are within the scope of the following claims. For example, one or more features from any embodiment may be combined with one or more features of any other embodiment without departing from the scope of the invention.

What is claimed is:

1. A method comprising:
for each user of a plurality of users of a data processing system, generating, by the data processing system, a user vector associated with the user, wherein the user vector includes one or more of seeded profile information of the user, interaction data of user interactions with knowledge elements of the data processing system, and knowledge element metadata of the knowledge elements that the user interacted with;
grouping, by the data processing system, the generated user vectors into clusters based on a clustering distance metric between the user vectors;
for each cluster:
determining a centroid of the cluster; and
associating with the cluster at least some of the knowledge elements that the users associated with the cluster has interacted with;
comparing, by the data processing system, a target user vector of a target user with the centroids of the clusters to determine a matching cluster for the target user; and
providing, by the data processing system, one or more recommendations of the knowledge elements that are associated with the matching cluster to the target user.

2. The method of claim 1, wherein the seeded profile information, the interaction data, and the knowledge element metadata are maskable when grouping the generated user vectors into the clusters.

3. The method of claim 1, wherein the seeded profile information of the user includes one or more of a job junction of the user, a role of the user, an expertise of the user, an age of the user, a location of the user, and a gender of the user.

4. The method of claim 1, wherein the user interactions between the user and a knowledge element includes one or more of viewing the knowledge element, commenting on the knowledge element, rating of the knowledge element, sharing of the knowledge element, and publishing of the knowledge element performed by the user.

5. The method of claim 1, wherein the knowledge element metadata of a knowledge element includes one or more of key terms associated with the knowledge element, a publisher of the knowledge element, a title of the knowledge element, a topic of the knowledge element, a category associated with the knowledge element, and a timestamp of the knowledge element.

6. The method of claim 1, wherein providing the one or more recommendations includes filtering out knowledge elements that the target user has consumed.

7. The method of claim 1, wherein providing the one or more recommendations includes filtering out knowledge elements that are stale.

8. A non-transitory computer-readable storage memory storing a plurality of instructions executable by one or more processors, the plurality of instructions comprising:
instructions that cause the one or more processors to, for each user of a plurality of users, generate a user vector associated with the user, wherein the user vector includes one or more of seeded profile information of the user, interaction data of user interactions with knowledge elements of the data processing system, and knowledge element metadata of the knowledge elements that the user interacted with;
instructions that cause the one or more processors to group the generated user vectors into clusters based on a clustering distance metric between the user vectors;
instructions that cause the one or more processors to, for each cluster, determine a centroid of the cluster, and associate with the cluster at least some of the knowledge elements that the users associated with the cluster has interacted with;
instructions that cause the one or more processors to compare a target user vector of a target user with the centroids of the clusters to determine a matching cluster for the target user; and
instructions that cause the one or more processors to provide one or more recommendations of the knowledge elements that are associated with the matching cluster to the target user.

9. The non-transitory computer-readable storage memory of claim 8, wherein the seeded profile information, the interaction data, and the knowledge element metadata are maskable when grouping the generated user vectors into the clusters.

10. The non-transitory computer-readable storage memory of claim 8, wherein the seeded profile information of the user includes one or more of a job junction of the user, a role of the user, an expertise of the user, an age of the user, a location of the user, and a gender of the user.

11. The non-transitory computer-readable storage memory of claim 8, wherein the user interactions between the user and a knowledge element includes one or more of viewing the knowledge element, commenting on the knowledge element, rating of the knowledge element, sharing of the knowledge element, and publishing of the knowledge element performed by the user.

12. The non-transitory computer-readable storage memory of claim 8, wherein the knowledge element metadata of a knowledge element includes one or more of key terms associated with the knowledge element, a publisher of the knowledge element, a title of the knowledge element, a topic of the knowledge element, a category associated with the knowledge element, and a timestamp of the knowledge element.

13. The non-transitory computer-readable storage memory of claim 8, wherein the plurality of instructions further includes instructions that cause the one or more processors to filter out knowledge elements that the target user has consumed when providing the one or more recommendations.

14. The non-transitory computer-readable storage memory of claim 8, wherein the plurality of instructions further includes instructions that cause the one or more processors to filter out knowledge elements that are stale when providing the one or more recommendations.

15. A system comprising:
one or more processors; and
a memory coupled with and readable by the one or more processors, the memory configured to store a set of instructions which, when executed by the one or more processors, causes the one or more processors to:
for each user of a plurality of users, generate a user vector associated with the user, wherein the user vector includes one or more of seeded profile information of the user, interaction data of user interactions with knowledge elements of the data processing system, and knowledge element metadata of the knowledge elements that the user interacted with;
group the generated user vectors into clusters based on a clustering distance metric between the user vectors;
for each cluster:
determine a centroid of the cluster; and
associate with the cluster at least some of the knowledge elements that the users associated with the cluster has interacted with;
compare a target user vector of a target user with the centroids of the clusters to determine a matching cluster for the target user; and
provide one or more recommendations of the knowledge elements that are associated with the matching cluster to the target user.

16. The system of claim 15, wherein the seeded profile information, the interaction data, and the knowledge element metadata are maskable when grouping the generated user vectors into the clusters.

17. The system of claim 15, wherein the seeded profile information of the user includes one or more of a job junction of the user, a role of the user, an expertise of the user, an age of the user, a location of the user, and a gender of the user.

18. The system of claim 15, wherein the user interactions between the user and a knowledge element includes one or more of viewing the knowledge element, commenting on the knowledge element, rating of the knowledge element, sharing of the knowledge element, and publishing of the knowledge element performed by the user.

19. The system of claim 15, wherein the knowledge element metadata of a knowledge element includes one or more of key terms associated with the knowledge element, a publisher of the knowledge element, a title of the knowledge element, a topic of the knowledge element, a category associated with the knowledge element, and a timestamp of the knowledge element.

20. The system of claim 19, wherein the set of instructions further comprises instructions, which when executed by the one or more processors, causes the one or more processors to filter out knowledge elements that the target user has consumed when providing the one or more recommendations.
